(19) United States
(12) Patent Application Publication
(10) Pub. No.: US 2022/0121008 A1
(43) Pub. Date: Apr. 21, 2022

(54) OPTICAL IMAGING LENS

(71) Applicant: Genius Electronic Optical (Xiamen) Co., Ltd., Xiamen (CN)

(72) Inventors: HUABIN LIAO, Xiamen (CN); CHUANBO DONG, Xiamen (CN); HAI LIN, Xiamen (CN); HUNG-CHIEN HSIEH, Xiamen (CN)

(73) Assignee: Genius Electronic Optical (Xiamen) Co., Ltd., Xiamen (CN)

(21) Appl. No.: 17/136,994

(22) Filed: Dec. 29, 2020

(30) Foreign Application Priority Data
Oct. 16, 2020 (CN) 202011110785.X

(51) Int. Cl. G02B 13/00; G02B 9/60; G02B 27/00; H04N 5/225

(52) U.S. Cl. CPC G02B 13/0045; H04N 5/2254; G02B 27/0025; G02B 9/60

(57) ABSTRACT

An optical imaging lens may include a first, a second, a third, a fourth and a fifth lens elements positioned in an order from an object side to an image side. Through designing concave and/or convex surfaces of the five lens elements, the improved optical imaging lens may provide better imaging quality while the effective focal length may be enlarged, and the f-number may be maintained.

### CROSS-REFERENCE TO RELATED APPLICATIONS

This application claims priority to P.R.C. Patent Application No. 202011110785.X titled “Optical Imaging Lens,” filed Oct. 16, 2020, with the State Intellectual Property Office of the People's Republic of China (SIPO).

### TECHNICAL FIELD

The present disclosure relates to optical imaging lenses, and particularly, optical imaging lenses having five lens elements.

### BACKGROUND

As the specifications of mobile electronical devices rapidly evolve, various types of key components, such as optical imaging lenses, are developed. The application of optical imaging lenses may provide photograph, video and telephoto functions. A telescope lens together with a wide-angle lens is capable to provide optical zooming function. The more lengthy an effective focal length of the telescope lens is, the greater magnification of the optical zooming is.

However, an increased focal length of the optical imaging lens will cause an increased f-number thereof to decrease the whole illuminance. Accordingly, designing an optical imaging lens with an increased effective focal length presenting acceptable imaging quality, f-number and yield may be goals of research and design in the industry.

### SUMMARY

In light of one of the problems mentioned above, the present disclosure provides for optical imaging lenses increasing effective focal length and maintaining f-number in view of achieving good imaging quality.

In an example embodiment, an optical imaging lens, applied for photograph and video in a mobile electronical device, such as cell phone, digital camera, tablet computer, personal digital assistant (PDA), may comprise at least five lens elements to increase effective focal length and maintain f-number when achieving good imaging quality.

In the specification, parameters used here are defined as follows: a thickness of the first lens element along the optical axis is represented by T1, a distance from the image-side surface of the first lens element to the object-side surface of the second lens element along the optical axis, i.e. an air gap between the first and second lens elements along the optical axis, is represented by G12, a thickness of the second lens element along the optical axis is represented by T2, a distance from the image-side surface of the second lens element to the object-side surface of the third lens element along the optical axis, i.e. an air gap between the second and third lens elements along the optical axis, is represented by G23, a thickness of the third lens element along the optical axis is represented by T3, a distance from the image-side surface of the third lens element to the object-side surface of the fourth lens element along the optical axis, i.e. an air gap between the third and fourth lens elements along the optical axis, is represented by G34, a thickness of the fourth lens element along the optical axis is represented by T4, a distance from the image-side surface of the fourth lens element to the object-side surface of the fifth lens element along the optical axis, i.e. an air gap between the fourth and fifth lens elements along the optical axis, is represented by G45, a thickness of the fifth lens element along the optical axis is represented by T5, a distance from the image-side surface of the fifth lens element to the object-side surface of the filtering unit along the optical axis is represented by G5F, a thickness of the filtering unit along the optical axis is represented by TTF, an air gap between the filtering unit and the image plane along the optical axis is represented by GFP, a focal length of the first lens element is represented by f1, a focal length of the second lens element is represented by f2, a focal length of the third lens element is represented by f3, a focal length of the fourth lens element is represented by f4, a focal length of the fifth lens element is represented by f5, a refractive index of the first lens element is represented by n1, a refractive index of the second lens element is represented by n2, a refractive index of the third lens element is represented by n3, a refractive index of the fourth lens element is represented by n4, a refractive index of the fifth lens element is represented by n5, an abbe number of the first lens element is represented by V1, an abbe number of the second lens element is represented by V2, an abbe number of the third lens element is represented by V3, an abbe number of the fourth lens element is represented by V4, an abbe number of the fifth lens element is represented by V5, a half field of view of the optical imaging lens is represented by HFOV, a f-number of the optical imaging lens is represented by Fno, an effective focal length of the optical imaging lens is represented by EFL, a distance from the object-side surface of the first lens element to the image plane along the optical axis, i.e. a system length, is represented by TTL, a sum of the thicknesses of the first lens element, the second lens element, the third lens element, the fourth lens element, and the fifth lens element along the optical axis, i.e. a sum of the thicknesses of all five lens elements from the first lens element to the fifth lens element along the optical axis is represented by ALT, a sum of a distance between the image-side surface of the first lens element and the object-side surface of the second lens element, a distance between the image-side surface of the second lens element and the object-side surface of the third lens element, a distance between the image-side surface of the third lens element and the object-side surface of the fourth lens element and a distance between the image-side surface of the fourth lens element and the object-side surface of the fifth lens element, all of which are along with the optical axis, in other words, a sum of four air gaps from the first lens element to the fifth lens element along the optical axis, i.e. a sum of G12, G23, G34 and G45, is represented by AAG, a back focal length of the optical imaging lens, i.e. a distance from the image-side surface of the fifth lens element to the image plane along the optical axis is represented by BFL, a distance from the object-side surface of the first lens element to the image-side surface of the fifth lens element along the optical axis is represented by TL, an image height of the optical imaging lens is represented by ImgH, a distance from the image-side surface of the second lens element to the object-side surface of the fourth lens element along the optical axis is represented by D22t41, a distance from the object-side surface of the first lens element to the image-side surface of the second lens element along the optical axis is represented by D11t22, and a distance from the object-side surface of the third lens element to the image-side surface of the fifth lens element along the optical axis is represented by D31t52.

In an aspect of the present disclosure, in the optical imaging lens, comprising a first lens element, a second lens element, a third lens element, a fourth lens element and a fifth lens element sequentially from an object side to an image side along an optical axis, each of the first, second, third, fourth and fifth lens element having an object-side surface facing toward the object side and allowing imaging rays to pass through and an image-side surface facing toward the image side and allowing the imaging rays to pass through, the second lens element has negative refracting power, a periphery region of the object-side surface of the second lens element is convex, an optical axis region of the image-side surface of the third lens element is convex, a periphery region of the image-side surface of the fourth lens element is convex, and a periphery region of the image-side surface of the fifth lens element is convex. Lens elements included by the optical imaging lens are only the five lens elements described above, and the optical imaging lens satisfies the inequality:

EFL/(ImgH*Fno)≥1.800 Inequality (1).

In another aspect of the present disclosure, in the optical imaging lens, comprising a first lens element, a second lens element, a third lens element, a fourth lens element and a fifth lens element sequentially from an object side to an image side along an optical axis, each of the first, second, third, fourth and fifth lens element having an object-side surface facing toward the object side and allowing imaging rays to pass through and an image-side surface facing toward the image side and allowing the imaging rays to pass through, a periphery region of the object-side surface of the second lens element is convex, a periphery region of the image-side surface of the third lens element is convex, a periphery region of the image-side surface of the fourth lens element is convex, an optical axis region of the image-side surface of the fifth lens element is concave, and a periphery region of the image-side surface of the fifth lens element is convex. Lens elements included by the optical imaging lens are only the five lens elements described above, and the optical imaging lens satisfies Inequality (1): EFL/(ImgH*Fno)≥1.800.

In another aspect of the present disclosure, in the optical imaging lens, comprising a first lens element, a second lens element, a third lens element, a fourth lens element and a fifth lens element sequentially from an object side to an image side along an optical axis, each of the first, second, third, fourth and fifth lens element having an object-side surface facing toward the object side and allowing imaging rays to pass through and an image-side surface facing toward the image side and allowing the imaging rays to pass through, an optical axis region of the image-side surface of the first lens element is convex, an optical axis region of the object-side surface of the second lens element is convex, a periphery region of the object-side surface of the fourth lens element is concave, a periphery region of the image-side surface of the fourth lens element is convex, an optical axis region of the image-side surface of the fifth lens element is concave, a periphery region of the image-side surface of the fifth lens element is convex. Lens elements included by the optical imaging lens are only the five lens elements described above, and the optical imaging lens satisfies Inequality (1): EFL/(ImgH*Fno)≥1.800.

In another example embodiment, other inequality(s), such as those relating to the ratio among parameters could be taken into consideration. For example:

V3≥49.000 Inequality (2);

V4≤40.000 Inequality (3);

V5≥49.000 Inequality (4);

HFOV/AAG≥4.500 degree/mm Inequality (5);

HFOV*Fno/EFL≤2.200 degree/mm Inequality (6);

TL/(G23+G34)≤3.600 Inequality (7);

HFOV/D11t22≤5.000 degree/mm Inequality (8);

(ALT+BFL+ImgH)/(G23+G34)≤4.900 Inequality (9);

HFOV*Fno/TTL≤2.400 degree/mm Inequality (10);

HFOV*Fno/TL≤4.200 degree/mm Inequality (11);

HFOV/(G45+T5)≤11.700 degree/mm Inequality (12);

EFL/ImgH≥5.900 Inequality (13);

(D31t52+BFL)/D11t22≤2.600 Inequality (14);

D31t52/(T2+T3)≤4.500 Inequality (15);

(ALT+BFL)*Fno/D22t41≤2.750 Inequality (16);

(T1+T4+T5)/T3≤5.600 Inequality (17);

(T1+G12+T4+T5)/(T2+T3)≤5.200 Inequality (18).

In some example embodiments, more details about the convex or concave surface structure, refracting power or chosen material etc. could be incorporated for one specific lens element or broadly for a plurality of lens elements to improve the control for the system performance and/or resolution. It is noted that the details listed herein could be incorporated in example embodiments if no inconsistency occurs.

The optical imaging lens in example embodiments may provide better imaging quality while the effective focal length may be enlarged, and the f-number may be maintained through designing concave and/or convex surfaces of the five lens elements and satisfying an inequality.

### BRIEF DESCRIPTION OF THE DRAWINGS

Example embodiments will be more readily understood from the following detailed description when read in conjunction with the appended drawing, in which:

FIG. 1 depicts a cross-sectional view of one single lens element according to the present disclosure;

FIG. 2 depicts a cross-sectional view showing the relation between the shape of a portion and the position where a collimated ray meets the optical axis;

FIG. 3 depicts a cross-sectional view showing a first example of determining the shape of lens element regions and the boundaries of regions;

FIG. 4 depicts a cross-sectional view showing a second example of determining the shape of lens element regions and the boundaries of regions;

FIG. 5 depicts a cross-sectional view showing a third example of determining the shape of lens element regions and the boundaries of regions;

FIG. 6 depicts a cross-sectional view of a first embodiment of an optical imaging lens having five lens elements according to the present disclosure;

FIGS. 7(a)-7(d) depict a chart of a longitudinal spherical aberration and other kinds of optical aberrations of a first embodiment of the optical imaging lens according to the present disclosure;

FIG. 8 depicts a table of optical data for each lens element of a first embodiment of an optical imaging lens according to the present disclosure;

FIG. 9 depicts a table of aspherical data of a first embodiment of the optical imaging lens according to the present disclosure;

FIG. 10 depicts a cross-sectional view of a second embodiment of an optical imaging lens having five lens elements according to the present disclosure;

FIGS. 11(a)-11(d) depict a chart of a longitudinal spherical aberration and other kinds of optical aberrations of a second embodiment of the optical imaging lens according to the present disclosure;

FIG. 12 depicts a table of optical data for each lens element of the optical imaging lens of a second embodiment of the present disclosure;

FIG. 13 depicts a table of aspherical data of a second embodiment of the optical imaging lens according to the present disclosure;

FIG. 14 depicts a cross-sectional view of a third embodiment of an optical imaging lens having five lens elements according to the present disclosure;

FIGS. 15(a)-15(d) depict a chart of a longitudinal spherical aberration and other kinds of optical aberrations of a third embodiment of the optical imaging lens according to the present disclosure;

FIG. 16 depicts a table of optical data for each lens element of the optical imaging lens of a third embodiment of the present disclosure;

FIG. 17 depicts a table of aspherical data of a third embodiment of the optical imaging lens according to the present disclosure;

FIG. 18 depicts a cross-sectional view of a fourth embodiment of an optical imaging lens having five lens elements according to the present disclosure;

FIGS. 19(a)-19(d) depict a chart of a longitudinal spherical aberration and other kinds of optical aberrations of a fourth embodiment of the optical imaging lens according to the present disclosure;

FIG. 20 depicts a table of optical data for each lens element of the optical imaging lens of a fourth embodiment of the present disclosure;

FIG. 21 depicts a table of aspherical data of a fourth embodiment of the optical imaging lens according to the present disclosure;

FIG. 22 depicts a cross-sectional view of a fifth embodiment of an optical imaging lens having five lens elements according to the present disclosure;

FIGS. 23(a)-23(d) depict a chart of a longitudinal spherical aberration and other kinds of optical aberrations of a fifth embodiment of the optical imaging lens according to the present disclosure;

FIG. 24 depicts a table of optical data for each lens element of the optical imaging lens of a fifth embodiment of the present disclosure;

FIG. 25 depicts a table of aspherical data of a fifth embodiment of the optical imaging lens according to the present disclosure;

FIG. 26 depicts a cross-sectional view of a sixth embodiment of an optical imaging lens having five lens elements according to the present disclosure;

FIGS. 27(a)-27(d) depict a chart of a longitudinal spherical aberration and other kinds of optical aberrations of a sixth embodiment of the optical imaging lens according the present disclosure;

FIG. 28 depicts a table of optical data for each lens element of the optical imaging lens of a sixth embodiment of the present disclosure;

FIG. 29 depicts a table of aspherical data of a sixth embodiment of the optical imaging lens according to the present disclosure;

FIG. 30 depicts a cross-sectional view of a seventh embodiment of an optical imaging lens having five lens elements according to the present disclosure;

FIGS. 31(a)-31(d) depict a chart of a longitudinal spherical aberration and other kinds of optical aberrations of a seventh embodiment of the optical imaging lens according to the present disclosure;

FIG. 32 depicts a table of optical data for each lens element of a seventh embodiment of an optical imaging lens according to the present disclosure;

FIG. 33 depicts a table of aspherical data of a seventh embodiment of the optical imaging lens according to the present disclosure;

FIG. 34 depicts a cross-sectional view of an eighth embodiment of an optical imaging lens having five lens elements according to the present disclosure;

FIGS. 35(a)-35(d) depict a chart of a longitudinal spherical aberration and other kinds of optical aberrations of an eighth embodiment of the optical imaging lens according to the present disclosure;

FIG. 36 depicts a table of optical data for each lens element of an eighth embodiment of an optical imaging lens according to the present disclosure;

FIG. 37 depicts a table of aspherical data of an eighth embodiment of the optical imaging lens according to the present disclosure;

FIG. 38 depicts a cross-sectional view of a ninth embodiment of an optical imaging lens having five lens elements according to the present disclosure;

FIGS. 39(a)-39(d) depict a chart of a longitudinal spherical aberration and other kinds of optical aberrations of a ninth embodiment of the optical imaging lens according to the present disclosure;

FIG. 40 depicts a table of optical data for each lens element of a ninth embodiment of an optical imaging lens according to the present disclosure;

FIG. 41 depicts a table of aspherical data of a ninth embodiment of the optical imaging lens according to the present disclosure;

FIG. 42 depicts a cross-sectional view of a tenth embodiment of an optical imaging lens having five lens elements according to the present disclosure;

FIG. 43A depicts a table for the values of EFL/(ImgH*Fno), V3, V4, V5, HFOV/AAG, HFOV*Fno/EFL, TL/(G23+G34), HFOV/D11t22, (ALT+BFL+ImgH)/(G23+G34), HFOV*Fno/TTL, HFOV*Fno/TL, HFOV/(G45+T5), EFL/ImgH, (D31t52+BFL)/D11t22, D31t52/(T2+T3), (ALT+BFL)*Fno/D22t41, (T1+T4+T5)/T3 and (T1+G12+T4+T5)/(T2+T3) of the first to fifth example embodiments;

FIG. 43B depicts a table for the values of EFL/(ImgH*Fno), V3, V4, V5, HFOV/AAG, HFOV*Fno/EFL, TL/(G23+G34), HFOV/D11t22, (ALT+BFL+ImgH)/(G23+G34), HFOV*Fno/TTL, HFOV*Fno/TL, HFOV/(G45+T5), EFL/ImgH, (D31t52+BFL)/D11t22, D31t52/(T2+T3), (ALT+BFL)*Fno/D22t41, (T1+T4+T5)/T3 and (T1+G12+T4+T5)/(T2+T3) of the sixth to ninth example embodiments.

### DETAILED DESCRIPTION

The terms “optical axis region”, “periphery region”, “concave”, and “convex” used in this specification and claims should be interpreted based on the definition listed in the specification by the principle of lexicographer.

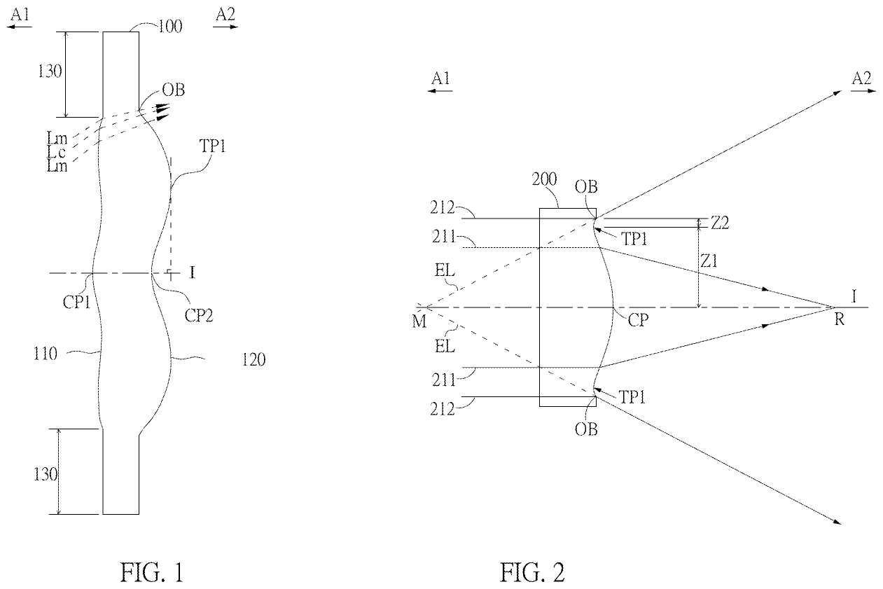

In the present disclosure, the optical system may comprise at least one lens element to receive imaging rays that are incident on the optical system over a set of angles ranging from parallel to an optical axis to a half field of view (HFOV) angle with respect to the optical axis. The imaging rays pass through the optical system to produce an image on an image plane. The term “a lens element having positive refracting power (or negative refracting power)” means that the paraxial refracting power of the lens element in Gaussian optics is positive (or negative). The term “an object-side (or image-side) surface of a lens element” refers to a specific region of that surface of the lens element at which imaging rays can pass through that specific region. Imaging rays include at least two types of rays: a chief ray Lc and a marginal ray Lm (as shown in FIG. 1). An object-side (or image-side) surface of a lens element can be characterized as having several regions, including an optical axis region, a periphery region, and, in some cases, one or more intermediate regions, as discussed more fully below.

FIG. 1 is a radial cross-sectional view of a lens element 100. Two referential points for the surfaces of the lens element 100 can be defined: a central point, and a transition point. The central point of a surface of a lens element is a point of intersection of that surface and the optical axis I. As illustrated in FIG. 1, a first central point CP1 may be present on the object-side surface 110 of lens element 100 and a second central point CP2 may be present on the image-side surface 120 of the lens element 100. The transition point is a point on a surface of a lens element, at which the line tangent to that point is perpendicular to the optical axis I. The optical boundary OB of a surface of the lens element is defined as a point at which the radially outermost marginal ray Lm passing through the surface of the lens element intersects the surface of the lens element. All transition points lie between the optical axis I and the optical boundary OB of the surface of the lens element. If multiple transition points are present on a single surface, then these transition points are sequentially named along the radial direction of the surface with reference numerals starting from the first transition point. For example, the first transition point, e.g., TP1, (closest to the optical axis I), the second transition point, e.g., TP2, (as shown in FIG. 4), and the Nth transition point (farthest from the optical axis I).

The region of a surface of the lens element from the central point to the first transition point TP1 is defined as the optical axis region, which includes the central point. The region located radially outside of the farthest Nth transition point from the optical axis I to the optical boundary OB of the surface of the lens element is defined as the periphery region. In some embodiments, there may be intermediate regions present between the optical axis region and the periphery region, with the number of intermediate regions depending on the number of the transition points.

The shape of a region is convex if a collimated ray being parallel to the optical axis I and passing through the region is bent toward the optical axis I such that the ray intersects the optical axis I on the image side A2 of the lens element. The shape of a region is concave if the extension line of a collimated ray being parallel to the optical axis I and passing through the region intersects the optical axis I on the object side A1 of the lens element.

Additionally, referring to FIG. 1, the lens element 100 may also have a mounting portion 130 extending radially outward from the optical boundary OB. The mounting portion 130 is typically used to physically secure the lens element to a corresponding element of the optical system (not shown). Imaging rays do not reach the mounting portion 130. The structure and shape of the mounting portion 130 are only examples to explain the technologies, and should not be taken as limiting the scope of the present disclosure. The mounting portion 130 of the lens elements discussed below may be partially or completely omitted in the following drawings.

Referring to FIG. 2, optical axis region Z1 is defined between central point CP and first transition point TP1. Periphery region Z2 is defined between TP1 and the optical boundary OB of the surface of the lens element. Collimated ray 211 intersects the optical axis I on the image side A2 of lens element 200 after passing through optical axis region Z1, i.e., the focal point of collimated ray 211 after passing through optical axis region Z1 is on the image side A2 of the lens element 200 at point R in FIG. 2. Accordingly, since the ray itself intersects the optical axis I on the image side A2 of the lens element 200, optical axis region Z1 is convex. On the contrary, collimated ray 212 diverges after passing through periphery region Z2. The extension line EL of collimated ray 212 after passing through periphery region Z2 intersects the optical axis I on the object side A1 of lens element 200, i.e., the focal point of collimated ray 212 after passing through periphery region Z2 is on the object side A1 at point M in FIG. 2. Accordingly, since the extension line EL of the ray intersects the optical axis I on the object side A1 of the lens element 200, periphery region Z2 is concave. In the lens element 200 illustrated in FIG. 2, the first transition point TP1 is the border of the optical axis region and the periphery region, i.e., TP1 is the point at which the shape changes from convex to concave.

Alternatively, there is another way for a person having ordinary skill in the art to determine whether an optical axis region is convex or concave by referring to the sign of “Radius” (the “R” value), which is the paraxial radius of shape of a lens surface in the optical axis region. The R value is commonly used in conventional optical design software such as Zemax and CodeV. The R value usually appears in the lens data sheet in the software. For an object-side surface, a positive R value defines that the optical axis region of the object-side surface is convex, and a negative R value defines that the optical axis region of the object-side surface is concave. Conversely, for an image-side surface, a positive R value defines that the optical axis region of the image-side surface is concave, and a negative R value defines that the optical axis region of the image-side surface is convex. The result found by using this method should be consistent with the method utilizing intersection of the optical axis by rays/extension lines mentioned above, which determines surface shape by referring to whether the focal point of a collimated ray being parallel to the optical axis I is on the object-side or the image-side of a lens element. As used herein, the terms “a shape of a region is convex (concave),” “a region is convex (concave),” and “a convex- (concave-) region,” can be used alternatively.

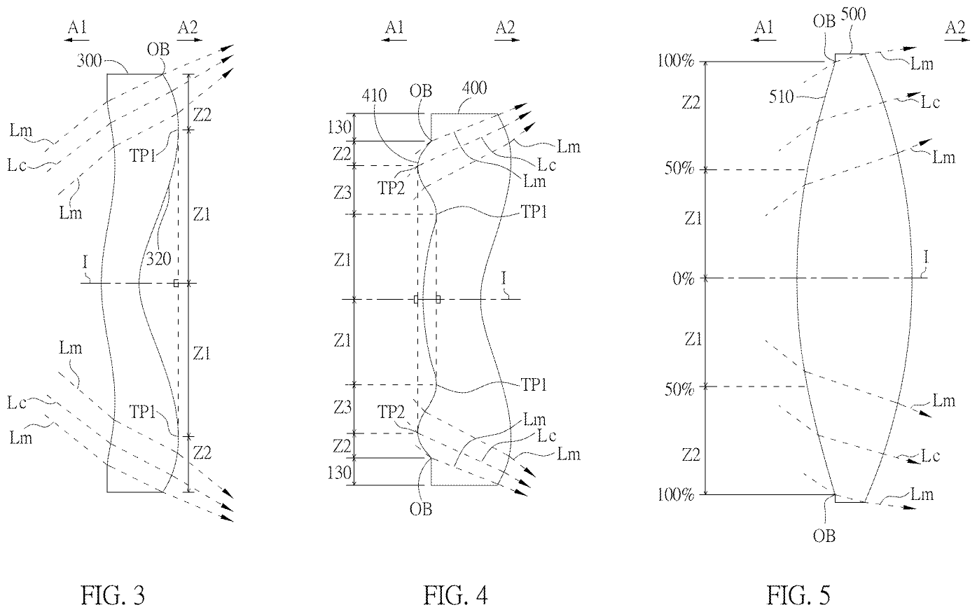

FIG. 3, FIG. 4 and FIG. 5 illustrate examples of determining the shape of lens element regions and the boundaries of regions under various circumstances, including the optical axis region, the periphery region, and intermediate regions as set forth in the present specification.

FIG. 3 is a radial cross-sectional view of a lens element 300. As illustrated in FIG. 3, only one transition point TP1 appears within the optical boundary OB of the image-side surface 320 of the lens element 300. Optical axis region Z1 and periphery region Z2 of the image-side surface 320 of lens element 300 are illustrated. The R value of the image-side surface 320 is positive (i.e., R>0). Accordingly, the optical axis region Z1 is concave.

In general, the shape of each region demarcated by the transition point will have an opposite shape to the shape of the adjacent region(s). Accordingly, the transition point will define a transition in shape, changing from concave to convex at the transition point or changing from convex to concave. In FIG. 3, since the shape of the optical axis region Z1 is concave, the shape of the periphery region Z2 will be convex as the shape changes at the transition point TP1.

FIG. 4 is a radial cross-sectional view of a lens element 400. Referring to FIG. 4, a first transition point TP1 and a second transition point TP2 are present on the object-side surface 410 of lens element 400. The optical axis region Z1 of the object-side surface 410 is defined between the optical axis I and the first transition point TP1. The R value of the object-side surface 410 is positive (i.e., R>0). Accordingly, the optical axis region Z1 is convex.

The periphery region Z2 of the object-side surface 410, which is also convex, is defined between the second transition point TP2 and the optical boundary OB of the object-side surface 410 of the lens element 400. Further, intermediate region Z3 of the object-side surface 410, which is concave, is defined between the first transition point TP1 and the second transition point TP2. Referring once again to FIG. 4, the object-side surface 410 includes an optical axis region Z1 located between the optical axis I and the first transition point TP1, an intermediate region Z3 located between the first transition point TP1 and the second transition point TP2, and a periphery region Z2 located between the second transition point TP2 and the optical boundary OB of the object-side surface 410. Since the shape of the optical axis region Z1 is designed to be convex, the shape of the intermediate region Z3 is concave as the shape of the intermediate region Z3 changes at the first transition point TP1, and the shape of the periphery region Z2 is convex as the shape of the periphery region Z2 changes at the second transition point TP2.

FIG. 5 is a radial cross-sectional view of a lens element 500. Lens element 500 has no transition point on the object-side surface 510 of the lens element 500. For a surface of a lens element with no transition point, for example, the object-side surface 510 the lens element 500, the optical axis region Z1 is defined as the region between 0-50% of the distance between the optical axis I and the optical boundary OB of the surface of the lens element and the periphery region is defined as the region between 50%-100% of the distance between the optical axis I and the optical boundary OB of the surface of the lens element. Referring to lens element 500 illustrated in FIG. 5, the optical axis region Z1 of the object-side surface 510 is defined between the optical axis I and 50% of the distance between the optical axis I and the optical boundary OB. The R value of the object-side surface 510 is positive (i.e., R>0). Accordingly, the optical axis region Z1 is convex. For the object-side surface 510 of the lens element 500, because there is no transition point, the periphery region Z2 of the object-side surface 510 is also convex. It should be noted that lens element 500 may have a mounting portion (not shown) extending radially outward from the periphery region Z2.

In the present disclosure, examples of an optical imaging lens are provided. Example embodiments of an optical imaging lens may comprise a first lens element, a second lens element, a third lens element, a fourth lens element and a fifth lens element. Each of the lens elements may comprise an object-side surface facing toward an object side allowing imaging rays to pass through and an image-side surface facing toward an image side allowing the imaging rays to pass through. These lens elements may be arranged sequentially from the object side to the image side along an optical axis, and example embodiments of the lens may have refracting power included by the optical imaging lens are only the five lens elements described above. Through controlling shape of the surfaces and range of the parameters, the optical imaging lens in example embodiments may provide better imaging quality while the effective focal length may be enlarged, and the f-number may be maintained.

In some embodiments, a periphery region of the image-side surface of the fourth lens element is convex, a periphery region of the image-side surface of the fifth lens element is convex and Inequality (1) is satisfied; preferably, 1.800≤EFL/(ImgH*Fno)≤3.400 may be satisfied. It may be beneficial to provide an optical imaging lens with long effective focal length, small f-number and good imaging quality and yield when the optical imaging lens further satisfies one of the combinations of condition as follows: (a) the second lens element has negative refracting power, a periphery region of the object-side surface of the second lens element is convex, and an optical axis region of the image-side surface of the third lens element is convex; (b) a periphery region of the object-side surface of the second lens element is convex, a periphery region of the image-side surface of the third lens element is convex, and an optical axis region of the image-side surface of the fifth lens element is concave; (c) an optical axis region of the image-side surface of the first lens element is convex, an optical axis region of the object-side surface of the second lens element is convex, a periphery region of the object-side surface of the fourth lens element is concave, and an optical axis region of the image-side surface of the fifth lens element is concave.

With proper materials chosen, when an optical imaging lens satisfies Inequality (2), Inequality (3), Inequality (4) and limitations of surface shape, it will be benefit to adjust chromatic aberration of the optical imaging lens to provide with long effective focal length and small f-number. Preferably, the optical imaging lens may further satisfy 49.000≤V3≤60.000, 19.000≤V4≤40.000, 49.000≤V5≤60.000 for a better configuration.

In some embodiments, when an optical imaging lens satisfies an aperture stop positioned between the second and third lens elements and limitations of surface shape, it will be benefit to provide with long effective focal length and small f-number.

In some embodiments, to shorten system length and ensure imaging quality, the thickness of at least one lens element and air gap between lens elements may be shortened. Therefore, when the optical imaging lens may satisfy Inequality (5)˜Inequality (18). Considering production or assembly difficulty, Inequality (5)˜Inequality (18) may be further limited within a preferred range for a better configuration:

0.700 degree/mm≤HFO V/AAG≤4.500 degree/mm;

0.800 degree/mm≤HFOV*Fno/EFL≤2.200 degree/mm;

1.300≤TL/(G23+G34)≤3.600;

0.600 degree/mm≤HFOV/D11t22≤5.000 degree/mm;

0.800≤(ALT+BFL+ImgH)/(G23+G34)≤4.900;

0.600 degree/mm≤HFOV*Fno/TTL≤2.400 degree/mm;

0.600 degree/mm≤HFOV*Fno/TL≤4.200 degree/mm;

3.800 degree/mm≤HFOV/(G45+T5)≤11.700 degree/mm;

5.900≤EFL/ImgH≤14.000;

0.700≤(D31t52+BFL)/D11t22≤2.600;

1.100≤D31t52/(T2+T3)≤4.500;

1.200≤(ALT+BFL)*Fno/D22t41≤2.750;

0.500≤(T1+T4+T5)/T3≤5.600;

0.600≤(T1+G12+T4+T5)/(T2+T3)≤5.200.

Further, limitation of optical imaging lenses may be added according to a combination of parameters in one of the example embodiment(s) from this disclosure. In light of the unpredictability in an optical system, satisfying these inequalities listed above may result in promoting the imaging quality, shortening the system length of the optical imaging lens, enlarging the aperture, promoting imaging quality and/or increasing the yield in the assembly process in the present disclosure.

Several example embodiments and associated optical data will now be provided for illustrating example embodiments of an optical imaging lens.

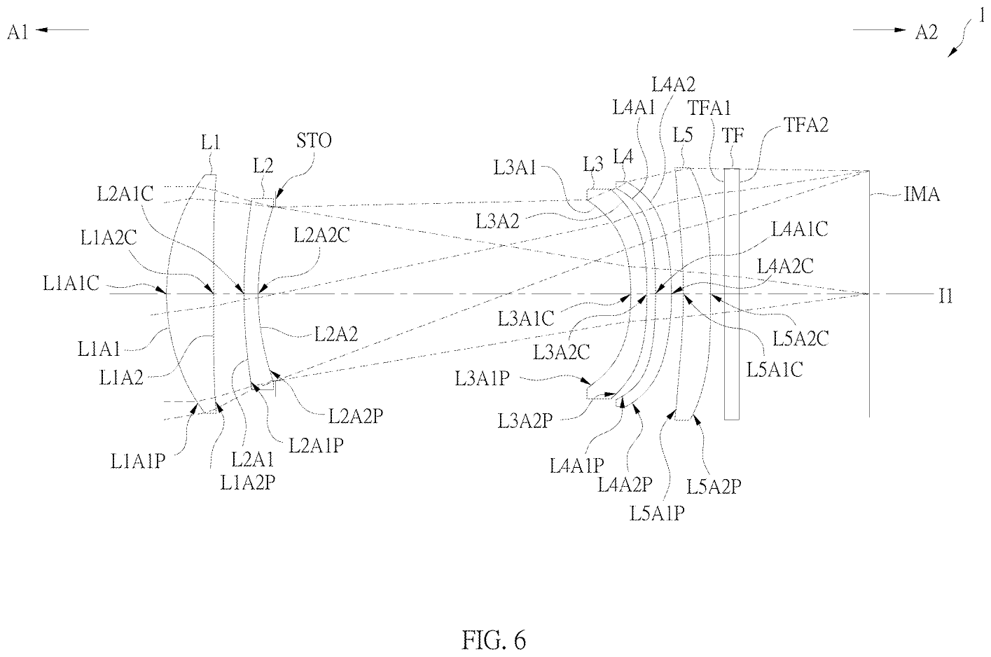

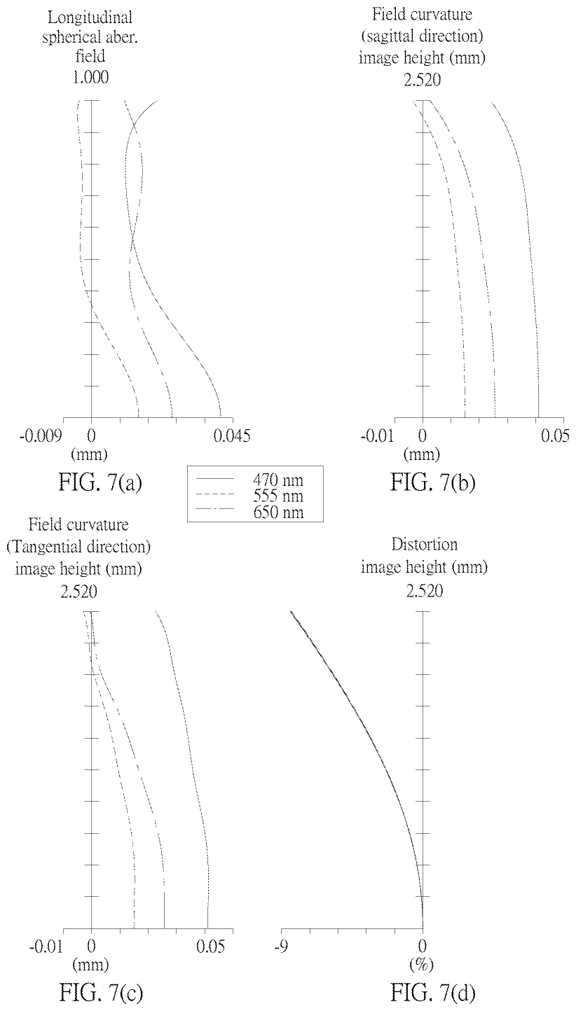

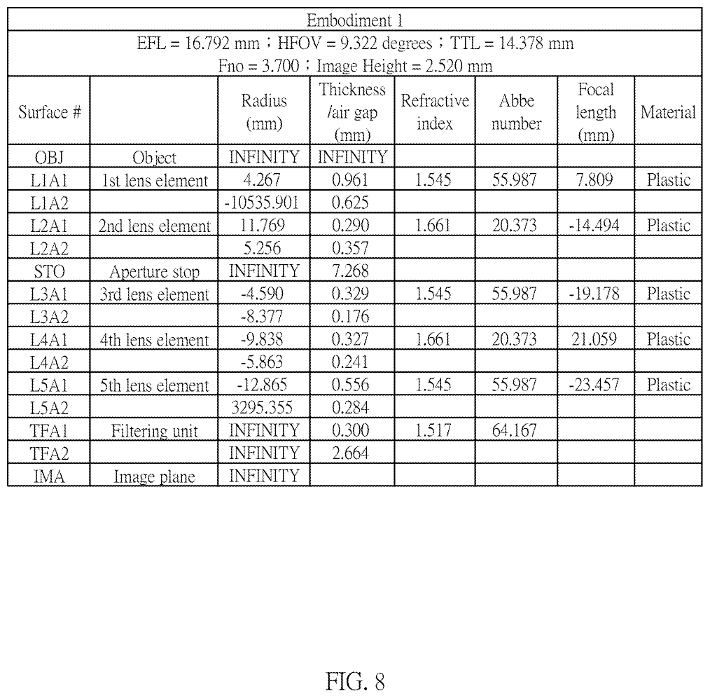

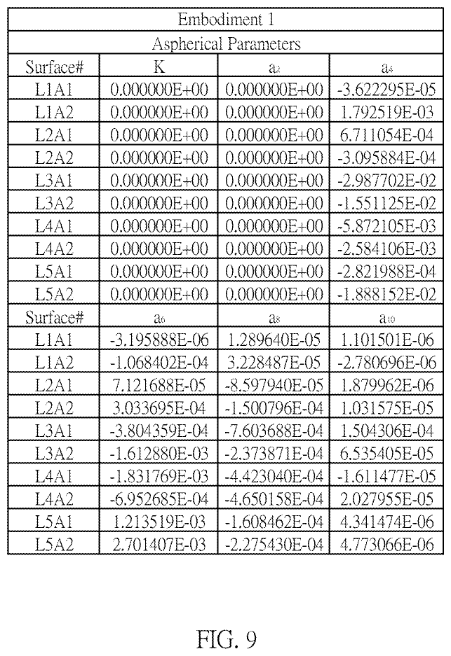

Reference is now made to FIGS. 6-9. FIG. 6 illustrates an example cross-sectional view of an optical imaging lens 1 having five lens elements of the optical imaging lens according to a first example embodiment. FIGS. 7(a)-7(d) show example charts of a longitudinal spherical aberration and other kinds of optical aberrations of the optical imaging lens 1 according to an example embodiment. FIG. 8 illustrates an example table of optical data of each lens element of the optical imaging lens 1 according to an example embodiment. FIG. 9 depicts an example table of aspherical data of the optical imaging lens 1 according to an example embodiment.

As shown in FIG. 6, the optical imaging lens 1 of the present embodiment may comprise, in the order from an object side A1 to an image side A2 along an optical axis, a first lens element L1, a second lens element L2, an aperture stop STO, a third lens element L3, a fourth lens element L4 and a fifth lens element L5. A filtering unit TF and an image plane IMA of an image sensor (not shown) may be positioned at the image side A2 of the optical lens 1. Each of the first, second, third, fourth and fifth lens element L1, L2, L3, L4, L5 and the filtering unit TF may comprise an object-side surface L1A1/L2A1/L3A1/L4A1/L5A1/TFA1 facing toward the object side A1 and an image-side surface L1A2/L2A2/L3A2/L4A2/L5A2/TFA2 facing toward the image side A2. The filtering unit TF, positioned between the fifth lens element L5 and the image plane IMA, may be, but not limited to, either an infrared cut-off filter selectively absorb light with specific wavelength(s) from the light passing through optical imaging lens 1 or a cover glass to protect the optical imaging lens 1.

Details of each lens element of the optical imaging lens 1 may be refer to the figures. To decrease weight and cost, the first, second, third, fourth and fifth lens elements L1, L2, L3, L4, L5 may be, but not limited to, constructed by plastic.

An example embodiment of the first lens element L1 may have positive refracting power. On the object-side surface L1A1, an optical axis region L1A1C may be convex and a periphery region L1A1P may be convex. On the image-side surface L1A2, an optical axis region L1A2C may be convex and a periphery region L1A2P may be concave.

An example embodiment of the second lens element L2 may have negative refracting power. On the object-side surface L2A1, an optical axis region L2A1C may be convex and a periphery region L2A1P may be convex. On the image-side surface L2A2, an optical axis region L2A2C may be concave and a periphery region L2A2P may be concave.

An example embodiment of the third lens element L3 may have negative refracting power. On the object-side surface L3A1, an optical axis region L3A1C may be concave and a periphery region L3A1P may be concave. On the image-side surface L3A2, an optical axis region L3A2C may be convex and a periphery region L3A2P may be convex.

An example embodiment of the fourth lens element L4 may have positive refracting power. On the object-side surface L4A1, an optical axis region L4A1C may be concave and a periphery region L4A1P may be concave. On the image-side surface L4A2, an optical axis region L4A2C may be convex and a periphery region L4A2P may be convex.

An example embodiment of the fifth lens element L5 may have negative refracting power. On the object-side surface L5A1, an optical axis region L5A1C may be concave and a periphery region L5A1P may be concave. On the image-side surface L5A2, an optical axis region L5A2C may be concave and a periphery region L5A2P may be convex.

The totaled 10 aspherical surfaces, including the object-side surface L1A1 and the image-side surface L1A2 of the first lens element L1, the object-side surface L2A1 and the image-side surface L2A2 of the second lens element L2, the object-side surface L3A1 and the image-side surface L3A2 of the third lens element L3, the object-side surface L4A1 and the image-side surface L4A2 of the fourth lens element L4, and the object-side surface L5A1 and the image-side surface L5A2 of the fifth lens element L5 may all be defined by the following aspherical formula, Formula (1):

$$Z ( Y ) = \frac{{Y}^{2}}{R} / ( 1 + \sqrt{1 - ( 1 + K ) \frac{{Y}^{2}}{{R}^{2}}} ) + {\sum }_{i = 1}^{n} {a}_{2 i} \times {Y}^{2 i} \qquad Formula ( 1 )$$

wherein, Y represents the perpendicular distance between the point of the aspherical surface and the optical axis; Z represents the depth of the aspherical surface (the perpendicular distance between the point of the aspherical surface at a distance Y from the optical axis and the tangent plane of the vertex on the optical axis of the aspherical surface); R represents the radius of curvature of the surface of the lens element; K represents a conic constant; a₂ᵢ represents an aspherical coefficient of 2i^{th} level.

The values of each aspherical parameter are shown in FIG. 9.

Referring to FIG. 7(a), a longitudinal spherical aberration of three different wavelengths (470 nm, 555 nm, 650 nm) of the optical imaging lens in the present embodiment is shown in coordinates in which the vertical axis represents field of view, and field curvature aberration of the optical imaging lens in the present embodiment in the sagittal direction is shown in FIG. 7(b), and field curvature aberration of the optical imaging lens in the present embodiment in the tangential direction is shown in FIG. 7(c), in which the vertical axis represents image height, and distortion aberration of the optical imaging lens in the present embodiment is shown in FIG. 7(d), in which the vertical axis represents image height. The curves of different wavelengths may be close to each other. This represents that off-axis light with respect to these wavelengths may be focused around an image point. From the longitudinal spherical aberration of each curve shown in FIG. 7(a), the offset of the off-axis light relative to the image point may be within ±0.045 mm. Therefore, the present embodiment may improve the longitudinal spherical aberration with respect to different wavelengths. For field curvature aberration in the sagittal direction, the focus variation with respect to the three wavelengths in the whole field may fall within ±0.05 mm, for field curvature aberration in the tangential direction, the focus variation with respect to the three wavelengths in the whole field may fall within ±0.05 mm, and the variation of the distortion aberration may be within ±9%.

The unit of image height, radius, thickness and focal length is millimeter. As shown in FIG. 8, the distance from the object-side surface L1A1 of the first lens element L1 to the image plane IMA along the optical axis, i.e. TTL is 14.378 mm, Fno is 3.700, HFOV is 9.322 degrees, EFL is 16.792 mm, ImgH is 2.520 mm. In light of the values of aberration shown in FIGS. 7(a)-7(b), the optical imaging lens 1 may be capable of increasing effective focal length, maintaining f-number and providing good imaging quality.

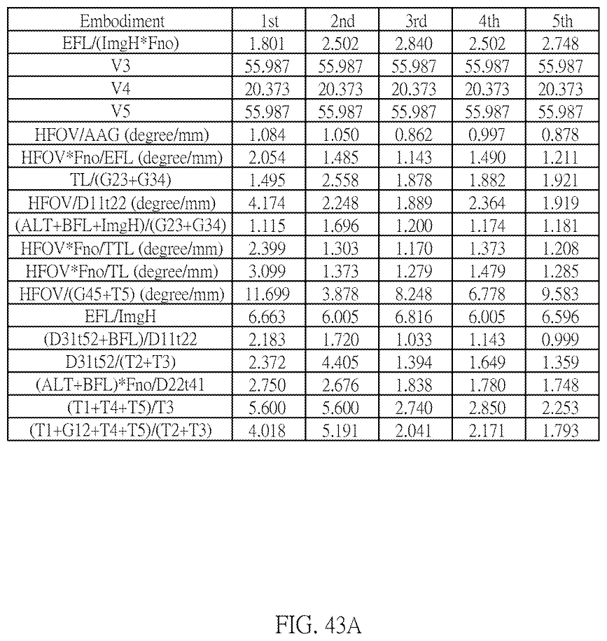

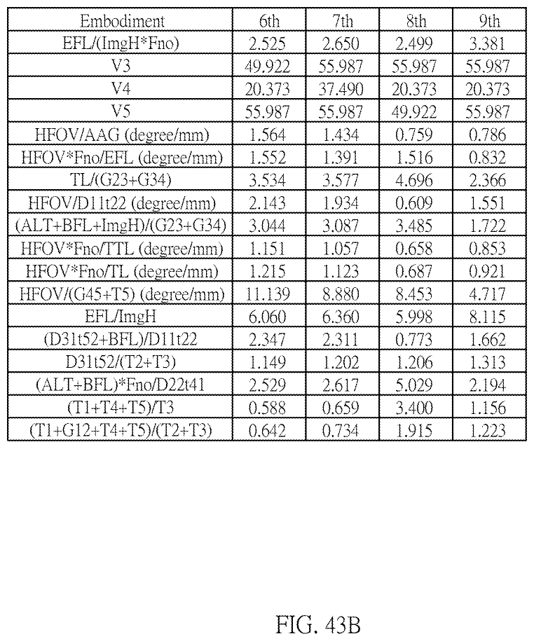

Please referring to FIG. 43A for the values of EFL/(ImgH*Fno), V3, V4, V5, HFOV/AAG, HFOV*Fno/EFL, TL/(G23+G34), HFOV/D11t22, (ALT+BFL+ImgH)/(G23+G34), HFOV*Fno/TTL, HFOV*Fno/TL, HFOV/(G45+T5), EFL/ImgH, (D31t52+BFL)/D11t22, D31t52/(T2+T3), (ALT+BFL)*Fno/D22t41, (T1+T4+T5)/T3, (T1+G12+T4+T5)/(T2+T3).

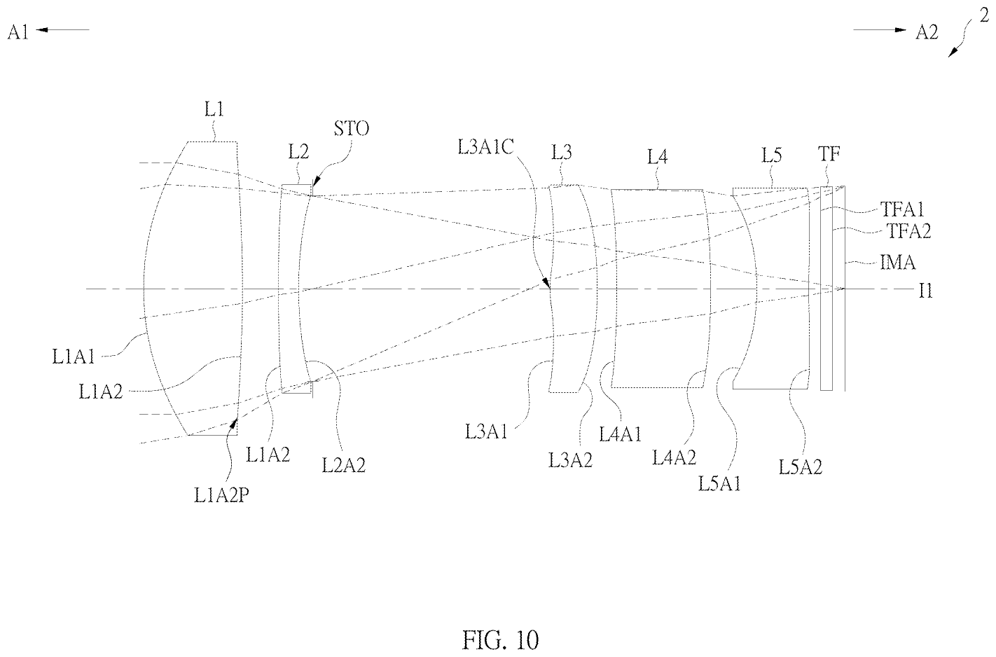

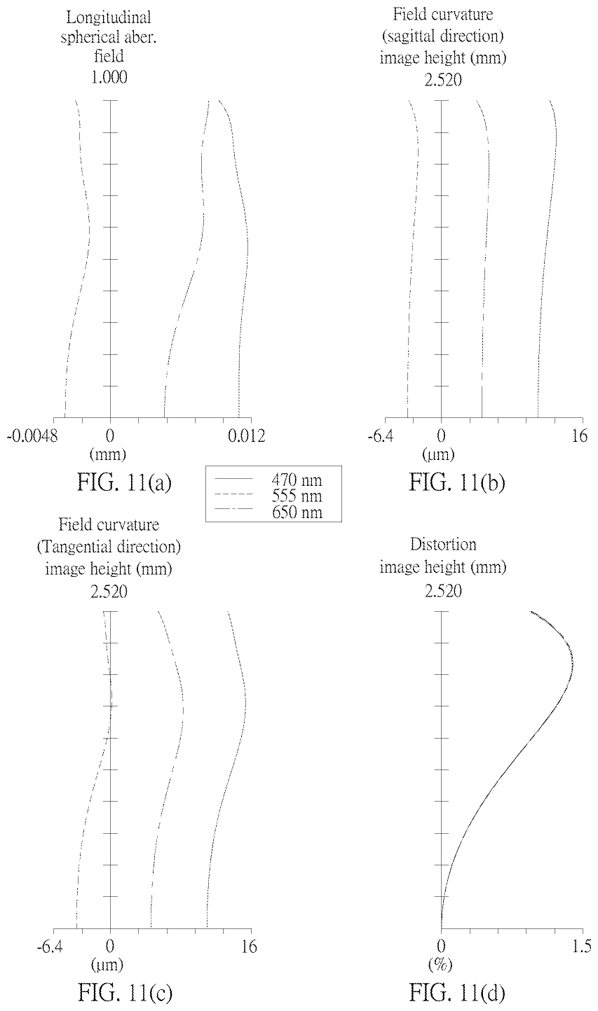

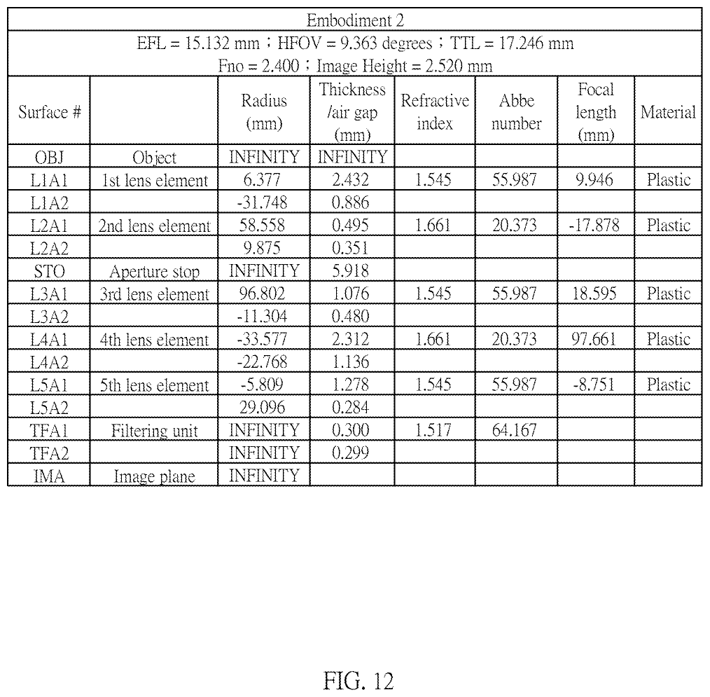

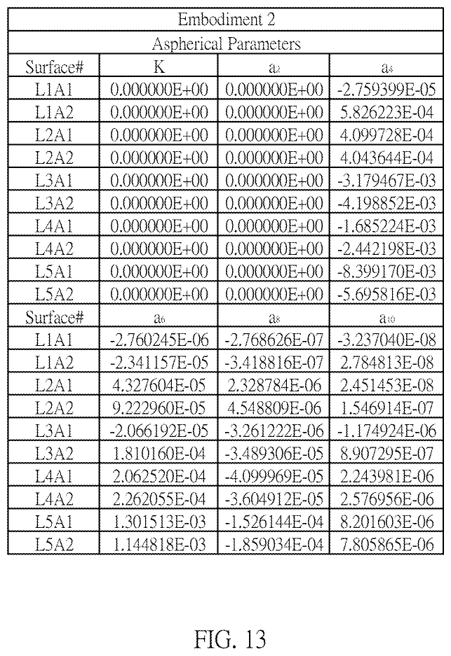

Reference is now made to FIGS. 10-13. FIG. 10 illustrates an example cross-sectional view of an optical imaging lens 2 having five lens elements of the optical imaging lens according to a second example embodiment. FIGS. 11(a)-11(d) show example charts of a longitudinal spherical aberration and other kinds of optical aberrations of the optical imaging lens 2 according to the second example embodiment. FIG. 12 shows an example table of optical data of each lens element of the optical imaging lens 2 according to the second example embodiment. FIG. 13 shows an example table of aspherical data of the optical imaging lens 2 according to the second example embodiment.

As shown in FIG. 10, the optical imaging lens 2 of the present embodiment, in an order from an object side A1 to an image side A2 along an optical axis, may comprise a first lens element L1, a second lens element L2, an aperture stop STO, a third lens element L3, a fourth lens element L4 and a fifth lens element L5.

The differences between the second embodiment and the first embodiment may include the radius of curvature, thickness of each lens element, aspherical data, related optical parameters, such as effective focal length, and the configuration of the concave/convex shape of the object-side surface L3A1 and the image-side surface L1A2; but the configuration of the concave/convex shape of surfaces, comprising the object-side surfaces L1A1, L2A1, L4A1, L5A1 and the image-side surfaces L2A2, L3A2, L4A2, L5A2, and positive or negative configuration of the refracting power of each lens element other than the third lens element L3 may be similar to those in the first embodiment. Specifically, the third lens element L3 has positive refracting power, a periphery region L1A2P of the image-side surface L1A2 of the first lens element L1 is convex, and an optical axis region L3A1C of the object-side surface L3A1 of the third lens element L3 is convex.

Here and in the embodiments hereinafter, for clearly showing the drawings of the present embodiment, only the surface shapes which are different from that in the first embodiment may be labeled. Please refer to FIG. 12 for the optical characteristics of each lens elements in the optical imaging lens 2 of the present embodiment.

As the longitudinal spherical aberration of three different wavelengths (470 nm, 555 nm, 650 nm) as shown in FIG. 11(a), the offset of the off-axis light relative to the image point may be within ±0.012 mm. As the field curvature aberration in the sagittal direction shown in FIG. 11(b), the focus variation with regard to the three wavelengths in the whole field may fall within ±16 μm. As the field curvature aberration in the tangential direction shown in FIG. 11(c), the focus variation with regard to the three wavelengths in the whole field may fall within ±16 μm. As shown in FIG. 11(d), the variation of the distortion aberration may be within ±1.5%.

As shown in FIGS. 11(a)-11(d) and 12, compared with the first embodiment, the longitudinal spherical aberration, the field curvature aberration in the sagittal direction, distortion aberration and f-number of the present embodiment are smaller.

Please refer to FIG. 43A for the values of EFL/(ImgH*Fno), V3, V4, V5, HFOV/AAG, HFOV*Fno/EFL, TL/(G23+G34), HFOV/D11t22, (ALT+BFL+ImgH)/(G23+G34), HFOV*Fno/TTL, HFOV*Fno/TL, HFOV/(G45+T5), EFL/ImgH, (D31t52+BFL)/D11t22, D31t52/(T2+T3), (ALT+BFL)*Fno/D22t41, (T1+T4+T5)/T3, (T1+G12+T4+T5)/(T2+T3) of the present embodiment.

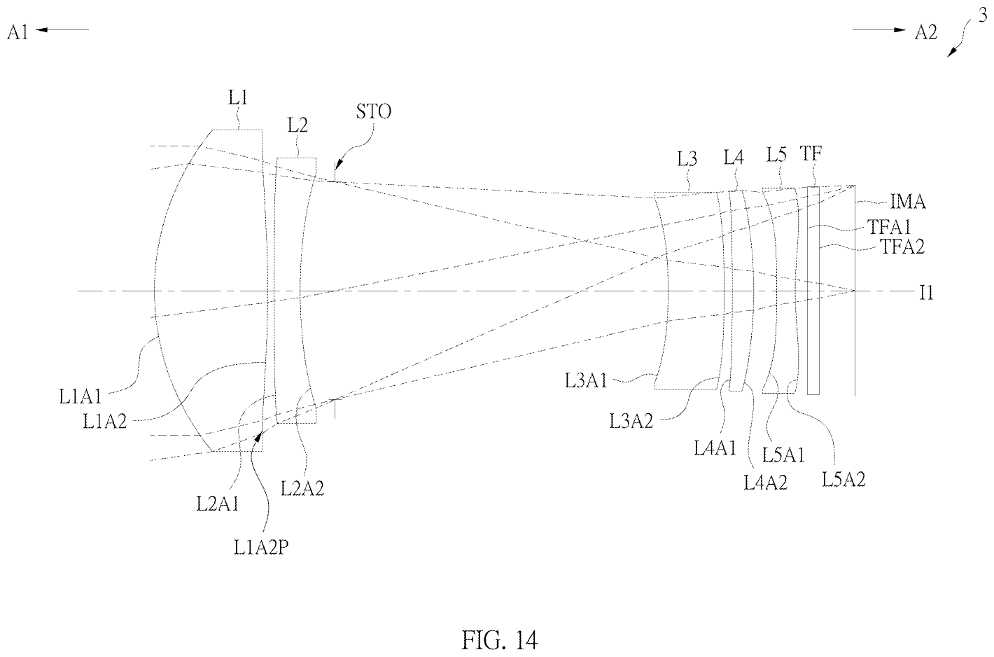

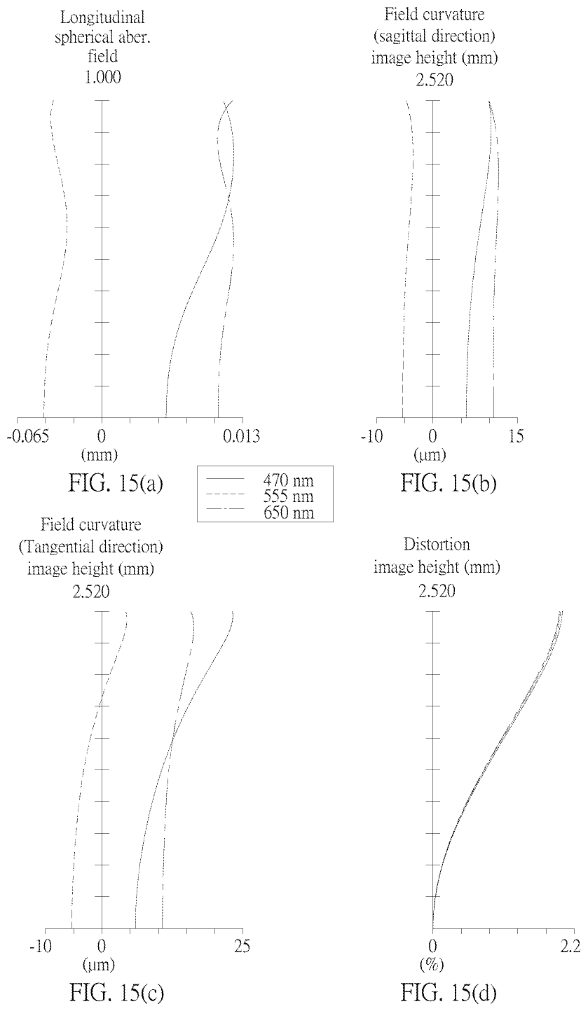

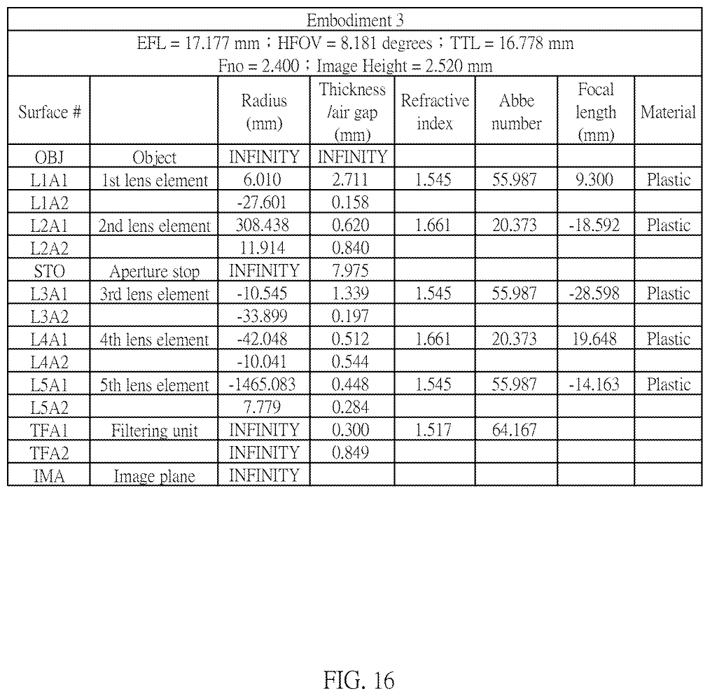

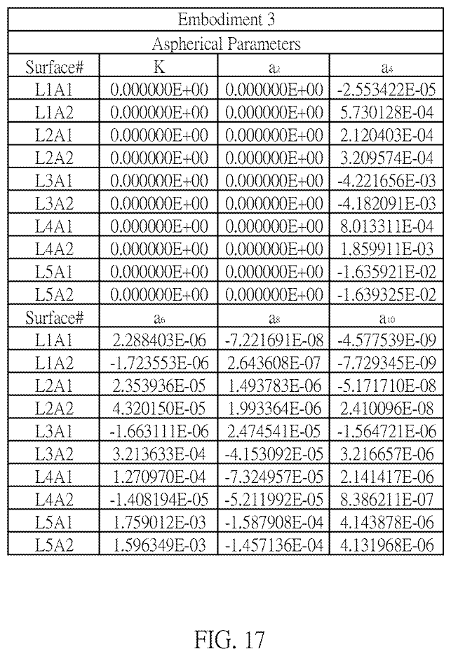

Reference is now made to FIGS. 14-17. FIG. 14 illustrates an example cross-sectional view of an optical imaging lens 3 having five lens elements of the optical imaging lens according to a third example embodiment. FIGS. 15(a)-15(d) show example charts of a longitudinal spherical aberration and other kinds of optical aberrations of the optical imaging lens 3 according to the third example embodiment. FIG. 16 shows an example table of optical data of each lens element of the optical imaging lens 3 according to the third example embodiment. FIG. 17 shows an example table of aspherical data of the optical imaging lens 3 according to the third example embodiment.

As shown in FIG. 14, the optical imaging lens 3 of the present embodiment, in an order from an object side A1 to an image side A2 along an optical axis, may comprise a first lens element L1, a second lens element L2, an aperture stop STO, a third lens element L3, a fourth lens element L4 and a fifth lens element L5.

The differences between the third embodiment and the first embodiment may include the radius of curvature, thickness of each lens element, aspherical data, related optical parameters, such as effective focal length, and the configuration of the concave/convex shape of the image-side surface L1A2; but the configuration of the concave/convex shape of surfaces, comprising the object-side surfaces UAL L2A1, L3A1, L4A1, L5A1 and the image-side surfaces L2A2, L3A2, L4A2, L5A2, and positive or negative configuration of the refracting power of each lens element may be similar to those in the first embodiment. Specifically, a periphery region L1A2P of the image-side surface L1A2 of the first lens element L1 is convex.

Here and in the embodiments hereinafter, for clearly showing the drawings of the present embodiment, only the surface shapes which are different from that in the first embodiment may be labeled. Please refer to FIG. 16 for the optical characteristics of each lens elements in the optical imaging lens 3 of the present embodiment.

As the longitudinal spherical aberration of three different wavelengths (470 nm, 555 nm, 650 nm) as shown in FIG. 15(a), the offset of the off-axis light relative to the image point may be within ±0.065 mm. As the field curvature aberration in the sagittal direction shown in FIG. 15(b), the focus variation with regard to the three wavelengths in the whole field may fall within ±15 μm. As the field curvature aberration in the tangential direction shown in FIG. 15(c), the focus variation with regard to the three wavelengths in the whole field may fall within ±25 μm. As shown in FIG. 15(d), the variation of the distortion aberration may be within ±2.2%.

As shown in FIGS. 15(a)-15(d) and 16, compared with the first embodiment, the longitudinal spherical aberration, the field curvature aberration in the tangential direction, distortion aberration and f-number of the present embodiment are smaller, and effective focal length of the present embodiment is greater.

Please refer to FIG. 43A for the values of EFL/(ImgH*Fno), V3, V4, V5, HFOV/AAG, HFOV*Fno/EFL, TL/(G23+G34), HFOV/D11t22, (ALT+BFL+ImgH)/(G23+G34), HFOV*Fno/TTL, HFOV*Fno/TL, HFOV/(G45+T5), EFL/ImgH, (D31t52+BFL)/D11t22, D31t52/(T2+T3), (ALT+BFL)*Fno/D22t41, (T1+T4+T5)/T3, (T1+G12+T4+T5)/(T2+T3) of the present embodiment.

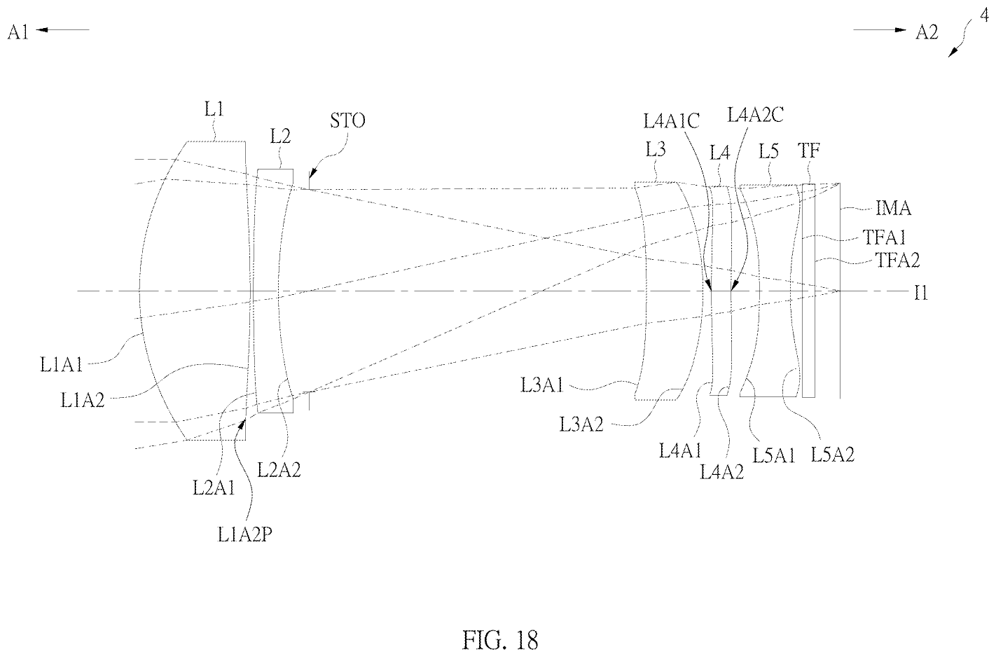

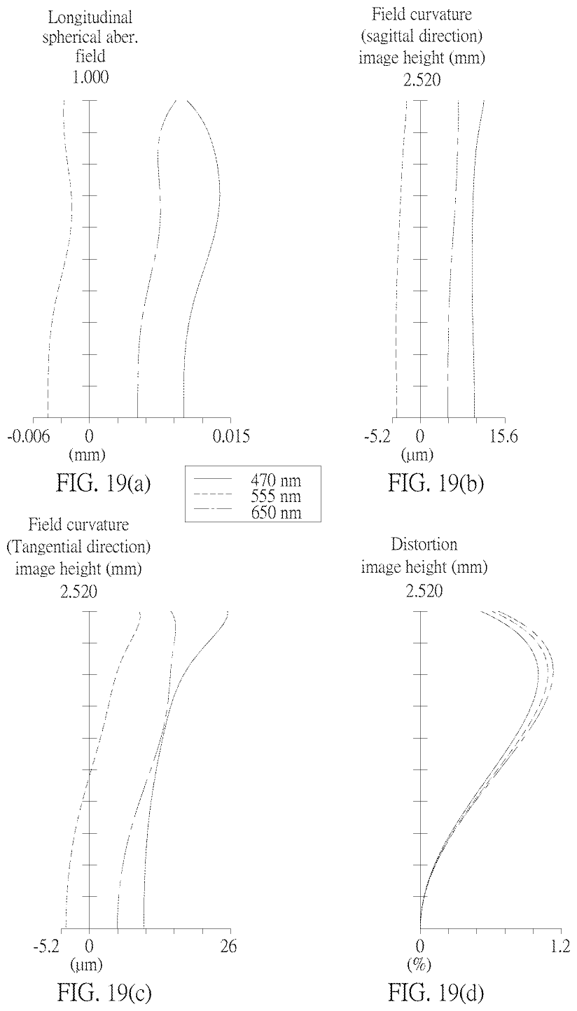

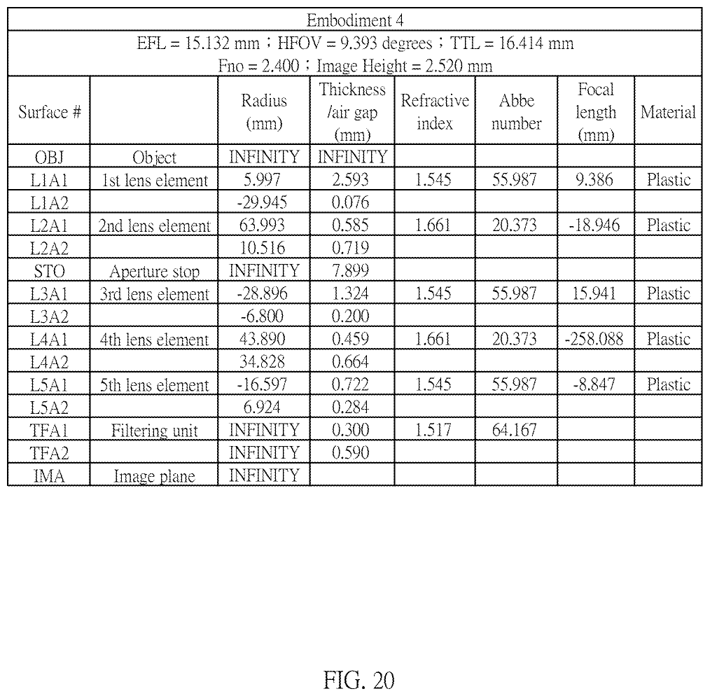

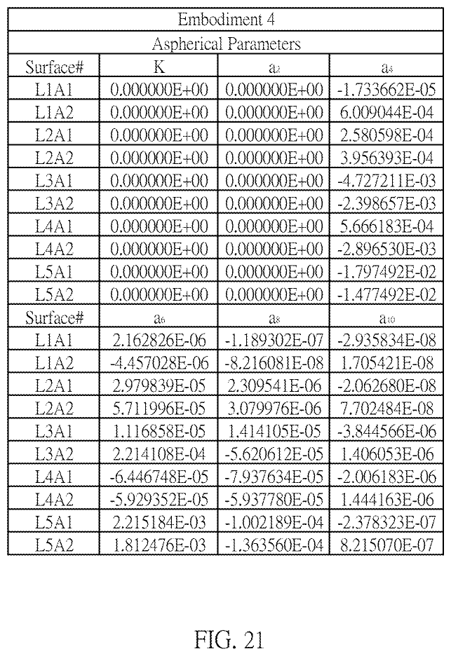

Reference is now made to FIGS. 18-21. FIG. 18 illustrates an example cross-sectional view of an optical imaging lens 4 having five lens elements of the optical imaging lens according to a fourth example embodiment. FIGS. 19(a)-19(d) show example charts of a longitudinal spherical aberration and other kinds of optical aberrations of the optical imaging lens 4 according to the fourth example embodiment. FIG. 20 shows an example table of optical data of each lens element of the optical imaging lens 4 according to the fourth example embodiment. FIG. 21 shows an example table of aspherical data of the optical imaging lens 4 according to the fourth example embodiment.

As shown in FIG. 18, the optical imaging lens 4 of the present embodiment, in an order from an object side A1 to an image side A2 along an optical axis, may comprise a first lens element L1, a second lens element L2, an aperture stop STO, a third lens element L3, a fourth lens element L4 and a fifth lens element L5.

The differences between the fourth embodiment and the first embodiment may include the radius of curvature, thickness of each lens element, aspherical data, related optical parameters, such as effective focal length, and the configuration of the concave/convex shape of the object-side surface L4A1 and the image-side surfaces L1A2, L4A2; but the configuration of the concave/convex shape of surfaces, comprising the object-side surfaces L1A1, L2A1, L3A1, L5A1 and the image-side surfaces L2A2, L3A2, L5A2, and positive or negative configuration of the refracting power of each lens element other than the third lens element L3 and the fourth lens element L4 may be similar to those in the first embodiment. Specifically, the third lens element L3 has positive refracting power, the fourth lens element L4 has negative refracting power, a periphery region L1A2P of the image-side surface L1A2 of the first lens element L1 is convex, an optical axis region L4A1C of the object-side surface L4A1 of the fourth lens element L4 is convex, and an optical axis region L4A2C of the image-side surface L4A2 of the fourth lens element L4 is concave.

Here and in the embodiments hereinafter, for clearly showing the drawings of the present embodiment, only the surface shapes which are different from that in the first embodiment may be labeled. Please refer to FIG. 20 for the optical characteristics of each lens elements in the optical imaging lens 4 of the present embodiment.

As the longitudinal spherical aberration of three different wavelengths (470 nm, 555 nm, 650 nm) as shown in FIG. 19(a), the offset of the off-axis light relative to the image point may be within ±0.015 mm. As the field curvature aberration in the sagittal direction shown in FIG. 19(b), the focus variation with regard to the three wavelengths in the whole field may fall within ±15.6 μm. As the field curvature aberration in the tangential direction shown in FIG. 19(c), the focus variation with regard to the three wavelengths in the whole field may fall within ±26 μm. As shown in FIG. 19(d), the variation of the distortion aberration may be within ±1.2%.

As shown in FIGS. 19(a)-19(d) and 20, compared with the first embodiment, the longitudinal spherical aberration, the field curvature aberration in both the sagittal and tangential directions, distortion aberration and f-number of the present embodiment are smaller.

Please refer to FIG. 43A for the values of EFL/(ImgH*Fno), V3, V4, V5, HFOV/AAG, HFOV*Fno/EFL, TL/(G23+G34), HFOV/D11t22, (ALT+BFL+ImgH)/(G23+G34), HFOV*Fno/TTL, HFOV*Fno/TL, HFOV/(G45+T5), EFL/ImgH, (D31t52+BFL)/D11t22, D31t52/(T2+T3), (ALT+BFL)*Fno/D22t41, (T1+T4+T5)/T3, (T1+G12+T4+T5)/(T2+T3) of the present embodiment.

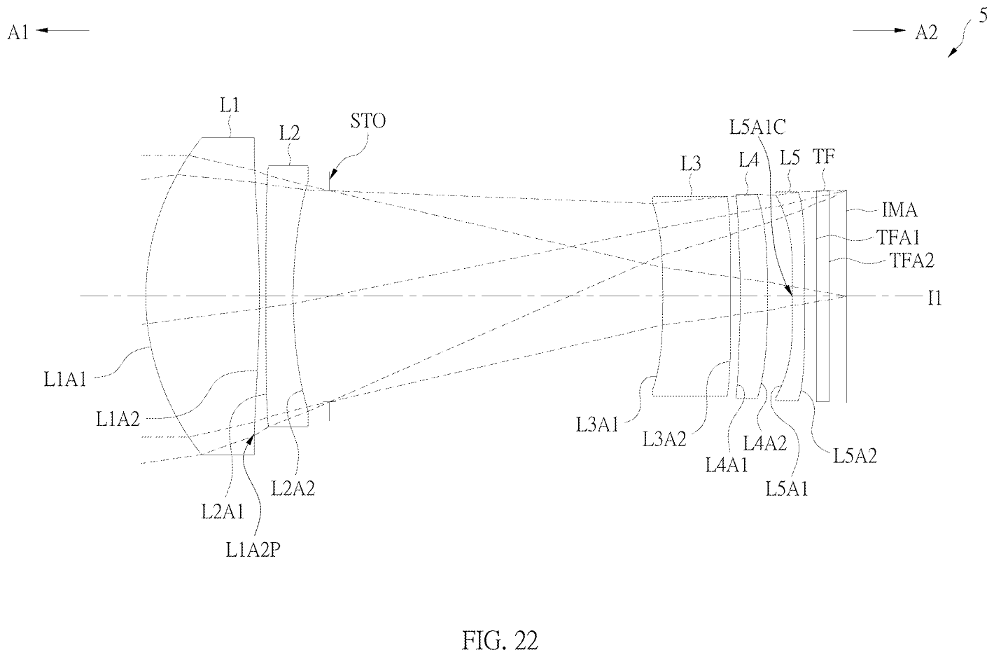

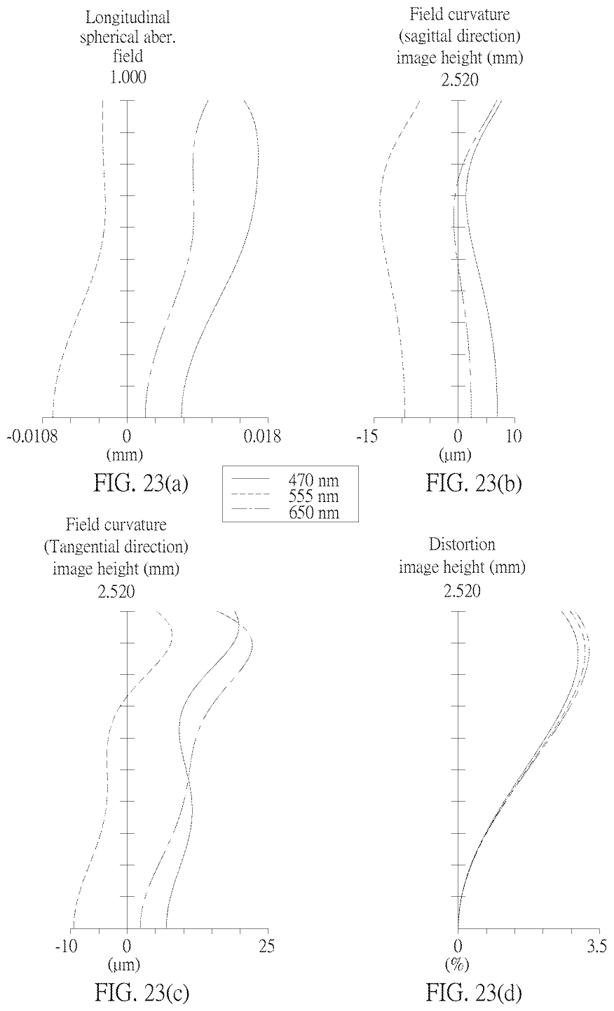

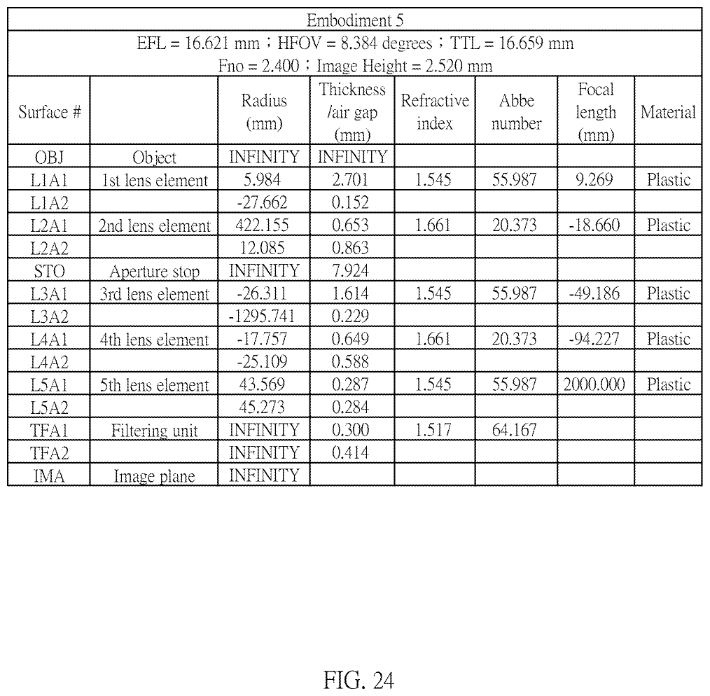

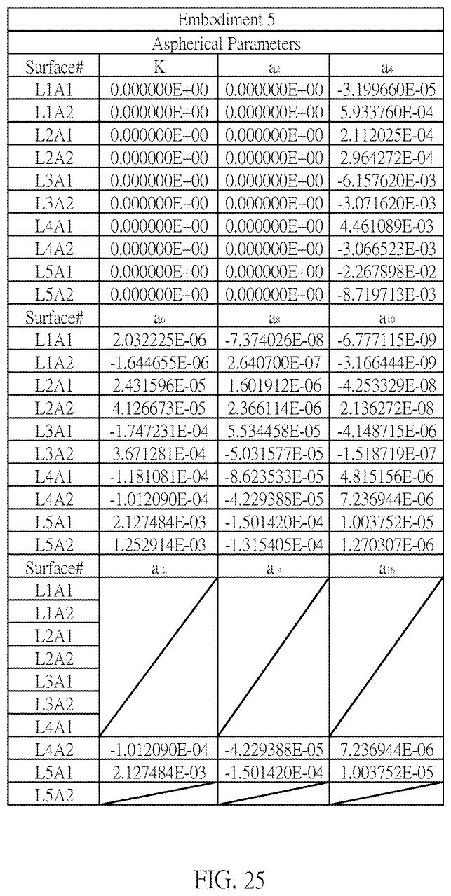

Reference is now made to FIGS. 22-25. FIG. 22 illustrates an example cross-sectional view of an optical imaging lens 5 having five lens elements of the optical imaging lens according to a fifth example embodiment. FIGS. 23(a)-23(d) show example charts of a longitudinal spherical aberration and other kinds of optical aberrations of the optical imaging lens 5 according to the fifth example embodiment. FIG. 24 shows an example table of optical data of each lens element of the optical imaging lens 5 according to the fifth example embodiment. FIG. 25 shows an example table of aspherical data of the optical imaging lens 5 according to the fifth example embodiment.

As shown in FIG. 22, the optical imaging lens 5 of the present embodiment, in an order from an object side A1 to an image side A2 along an optical axis, may comprise a first lens element L1, a second lens element L2, an aperture stop STO, a third lens element L3, a fourth lens element L4 and a fifth lens element L5.

The differences between the fifth embodiment and the first embodiment may include the radius of curvature, thickness of each lens element, aspherical data, related optical parameters, such as effective focal length, and the configuration of the concave/convex shape of the object-side surface L5A1 and the image-side surface L1A2; but the configuration of the concave/convex shape of surfaces, comprising the object-side surfaces L1A1, L2A1, L3A1, L4A1 and the image-side surfaces L2A2, L3A2, L4A2, L5A2, and positive or negative configuration of the refracting power of each lens element other than the fourth lens element L4 and the fifth lens element L5 may be similar to those in the first embodiment. Specifically, the fourth lens element L4 has negative refracting power, the fifth lens element L5 has positive refracting power, a periphery region L1A2P of the image-side surface L1A2 of the first lens element L1 is convex, and an optical axis region L5A1C of the object-side surface L5A1 of the fifth lens element L5 is convex.

Here and in the embodiments hereinafter, for clearly showing the drawings of the present embodiment, only the surface shapes which are different from that in the first embodiment may be labeled. Please refer to FIG. 24 for the optical characteristics of each lens elements in the optical imaging lens 5 of the present embodiment.

As the longitudinal spherical aberration of three different wavelengths (470 nm, 555 nm, 650 nm) as shown in FIG. 23(a), the offset of the off-axis light relative to the image point may be within ±0.018 mm. As the field curvature aberration in the sagittal direction shown in FIG. 23(b), the focus variation with regard to the three wavelengths in the whole field may fall within ±15 μm. As the field curvature aberration in the tangential direction shown in FIG. 23(c), the focus variation with regard to the three wavelengths in the whole field may fall within ±25 μm. As shown in FIG. 23(d), the variation of the distortion aberration may be within ±3.5%.

As shown in FIGS. 23(a)-23(d) and 24, compared with the first embodiment, the longitudinal spherical aberration, the field curvature aberration in both the sagittal and tangential directions, distortion aberration and f-number of the present embodiment are smaller.

Please refer to FIG. 43A for the values of EFL/(ImgH*Fno), V3, V4, V5, HFOV/AAG, HFOV*Fno/EFL, TL/(G23+G34), HFOV/D11t22, (ALT+BFL+ImgH)/(G23+G34), HFOV*Fno/TTL, HFOV*Fno/TL, HFOV/(G45+T5), EFL/ImgH, (D31t52+BFL)/D11t22, D31t52/(T2+T3), (ALT+BFL)*Fno/D22t41, (T1+T4+T5)/T3, (T1+G12+T4+T5)/(T2+T3) of the present embodiment.

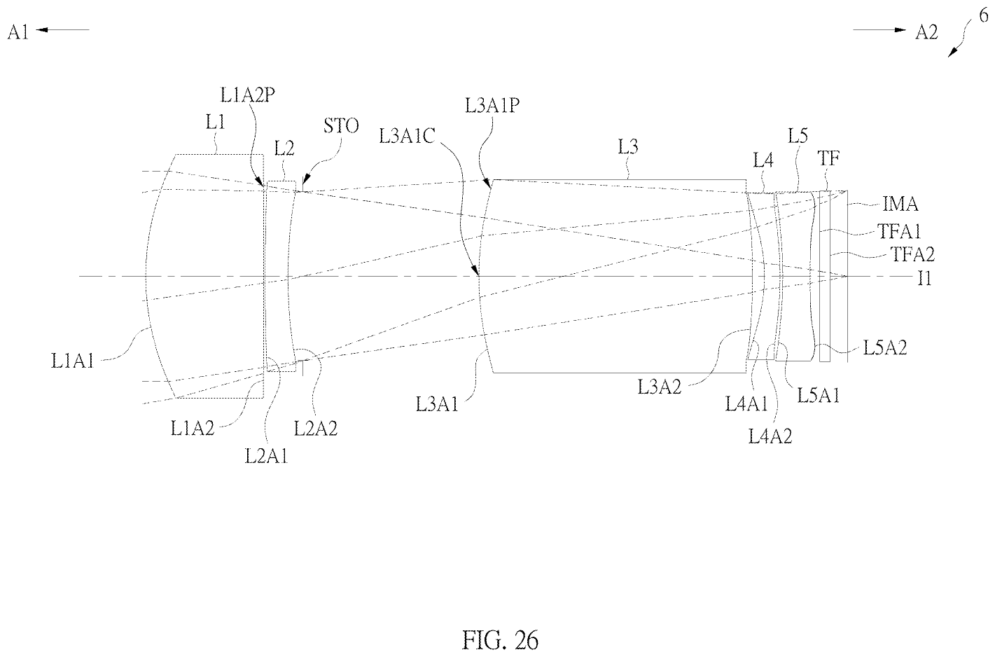

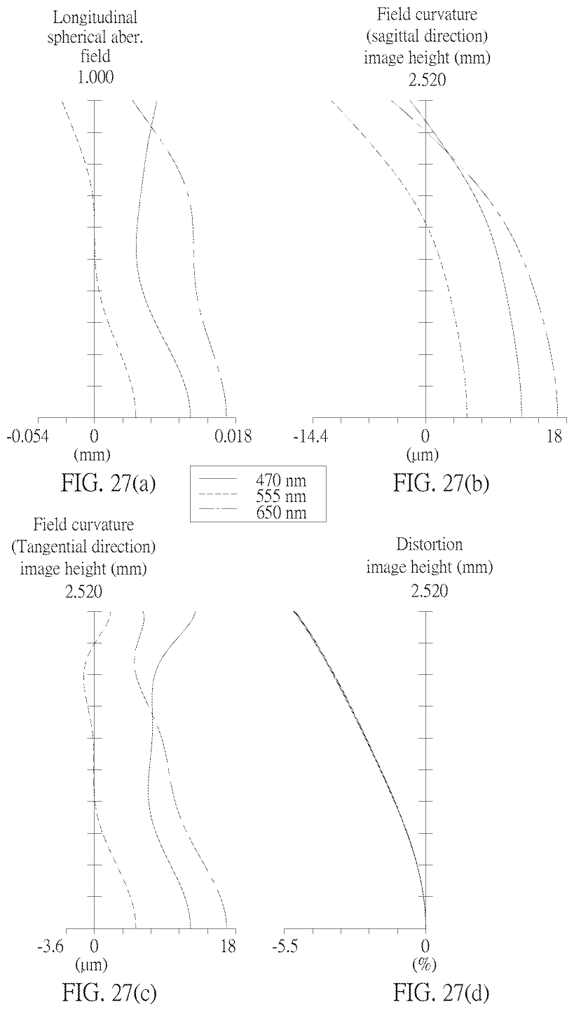

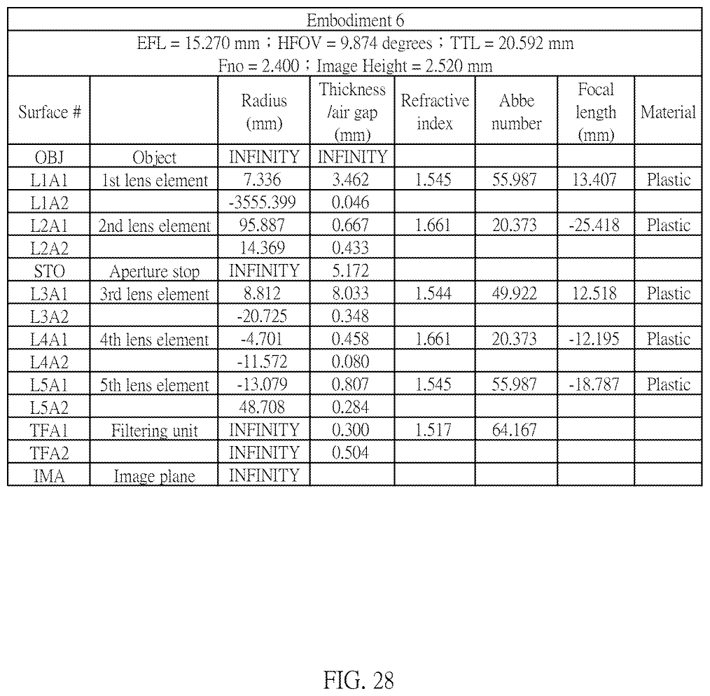

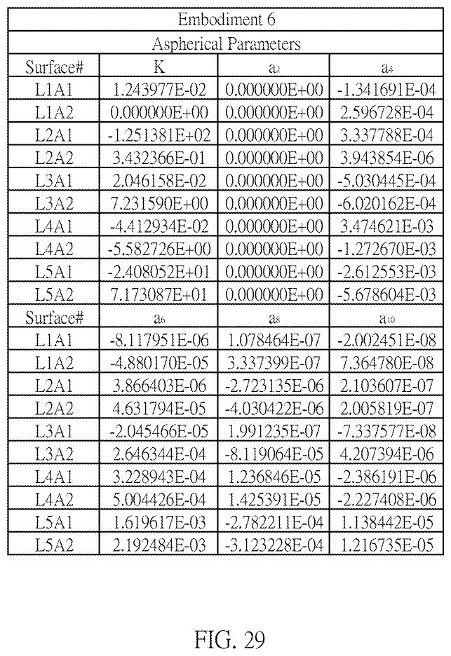

Reference is now made to FIGS. 26-29. FIG. 26 illustrates an example cross-sectional view of an optical imaging lens 6 having five lens elements of the optical imaging lens according to a sixth example embodiment. FIGS. 27(a)-27(d) show example charts of a longitudinal spherical aberration and other kinds of optical aberrations of the optical imaging lens 6 according to the sixth example embodiment. FIG. 28 shows an example table of optical data of each lens element of the optical imaging lens 6 according to the sixth example embodiment. FIG. 29 shows an example table of aspherical data of the optical imaging lens 6 according to the sixth example embodiment.

As shown in FIG. 26, the optical imaging lens 6 of the present embodiment, in an order from an object side A1 to an image side A2 along an optical axis, may comprise a first lens element L1, a second lens element L2, an aperture stop STO, a third lens element L3, a fourth lens element L4 and a fifth lens element L5.

The differences between the sixth embodiment and the first embodiment may include the radius of curvature, thickness of each lens element, aspherical data, related optical parameters, such as effective focal length, and the configuration of the concave/convex shape of the object-side surface L3A1 and the image-side surface L1A2; but the configuration of the concave/convex shape of surfaces, comprising the object-side surfaces L1A1, L2A1, L4A1, L5A1 and the image-side surfaces L2A2, L3A2, L4A2, L5A2, and positive or negative configuration of the refracting power of each lens element other than the third lens element L3 and the fourth lens element L4 may be similar to those in the first embodiment. Specifically, the third lens element L3 has positive refracting power, the fourth lens element L4 has negative refracting power, a periphery region L1A2P of the image-side surface L1A2 of the first lens element L1 is convex, an optical axis region L3A1C of the object-side surface L3A1 of the third lens element L3 is convex, and a periphery region L3A1P of the object-side surface L3A1 of the third lens element L3 is convex.

Here and in the embodiments hereinafter, for clearly showing the drawings of the present embodiment, only the surface shapes which are different from that in the first embodiment may be labeled. Please refer to FIG. 28 for the optical characteristics of each lens elements in the optical imaging lens 6 of the present embodiment.

As the longitudinal spherical aberration of three different wavelengths (470 nm, 555 nm, 650 nm) as shown in FIG. 27(a), the offset of the off-axis light relative to the image point may be within ±0.018 mm. As the field curvature aberration in the sagittal direction shown in FIG. 27(b), the focus variation with regard to the three wavelengths in the whole field may fall within ±18 μm. As the field curvature aberration in the tangential direction shown in FIG. 27(c), the focus variation with regard to the three wavelengths in the whole field may fall within ±18 μm. As shown in FIG. 27(d), the variation of the distortion aberration may be within ±5.5%.

As shown in FIGS. 27(a)-27(d) and 28, compared with the first embodiment, the longitudinal spherical aberration, the field curvature aberration in both the sagittal and tangential directions, distortion aberration and f-number of the present embodiment are smaller.

Please refer to FIG. 43B for the values of EFL/(ImgH*Fno), V3, V4, V5, HFOV/AAG, HFOV*Fno/EFL, TL/(G23+G34), HFOV/D11t22, (ALT+BFL+ImgH)/(G23+G34), HFOV*Fno/TTL, HFOV*Fno/TL, HFOV/(G45+T5), EFL/ImgH, (D31t52+BFL)/D11t22, D31t52/(T2+T3), (ALT+BFL)*Fno/D22t41, (T1+T4+T5)/T3, (T1+G12+T4+T5)/(T2+T3) of the present embodiment.

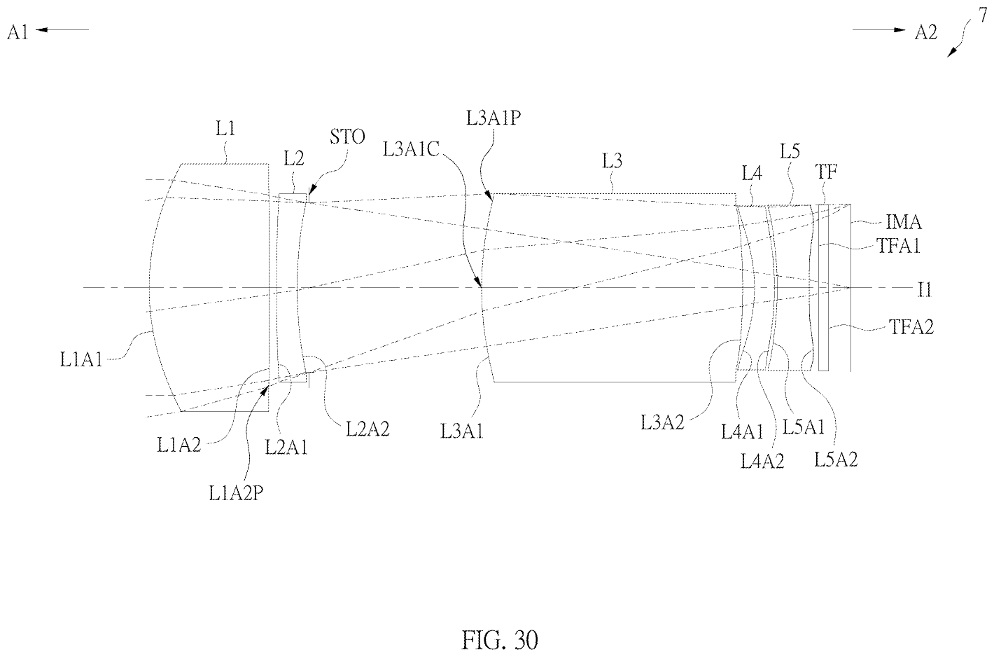

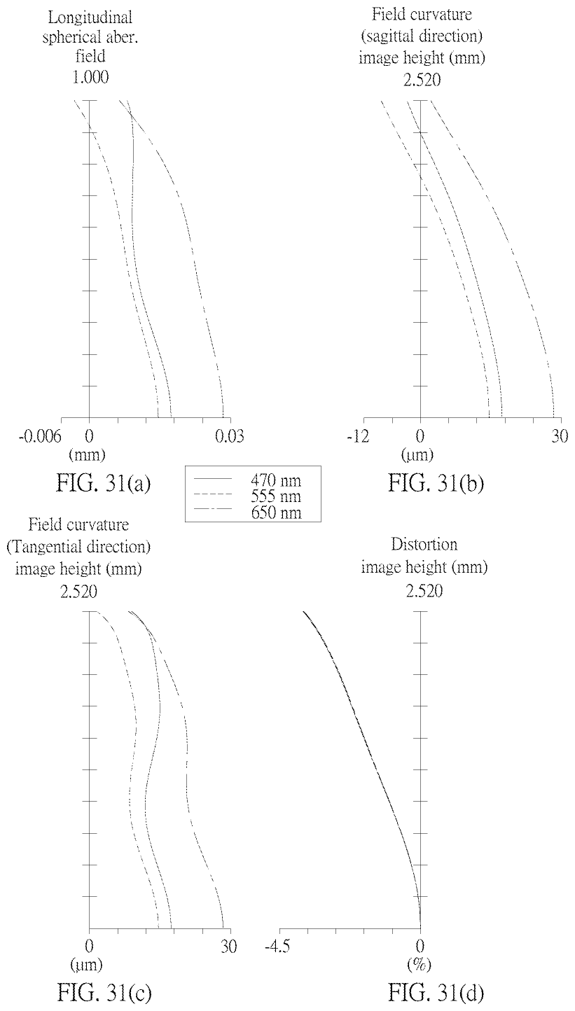

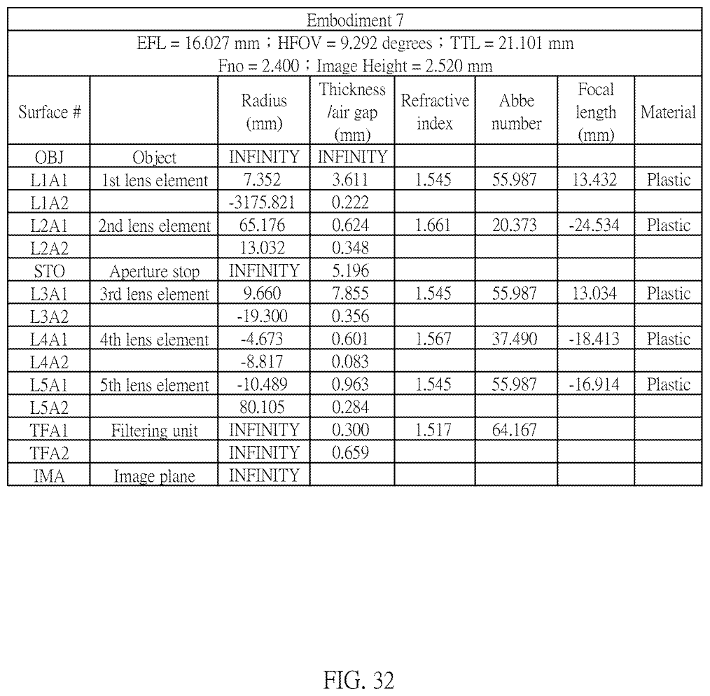

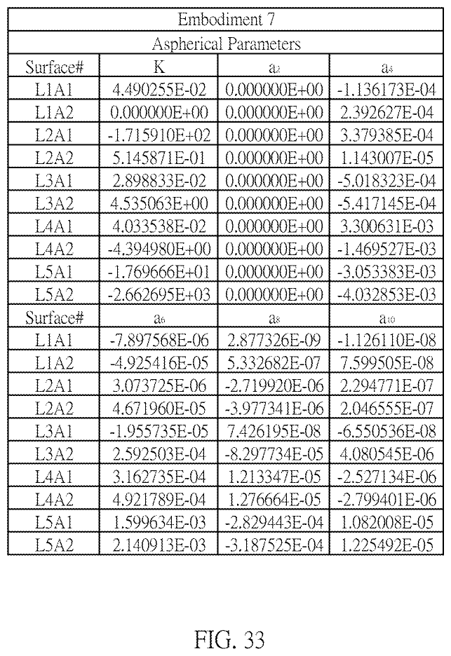

Reference is now made to FIGS. 30-33. FIG. 30 illustrates an example cross-sectional view of an optical imaging lens 7 having five lens elements of the optical imaging lens according to a seventh example embodiment. FIGS. 31(a)-31(d) show example charts of a longitudinal spherical aberration and other kinds of optical aberrations of the optical imaging lens 7 according to the seventh example embodiment. FIG. 32 shows an example table of optical data of each lens element of the optical imaging lens 7 according to the seventh example embodiment. FIG. 33 shows an example table of aspherical data of the optical imaging lens 7 according to the seventh example embodiment.

As shown in FIG. 30, the optical imaging lens 7 of the present embodiment, in an order from an object side A1 to an image side A2 along an optical axis, may comprise a first lens element L1, a second lens element L2, an aperture stop STO, a third lens element L3, a fourth lens element L4 and a fifth lens element L5.

The differences between the seventh embodiment and the first embodiment may include the radius of curvature, thickness of each lens element, aspherical data, related optical parameters, such as effective focal length, and the configuration of the concave/convex shape of the object-side surface L3A1 and the image-side surface L1A2; but the configuration of the concave/convex shape of surfaces, comprising the object-side surfaces L1A1, L2A1, L4A1, L5A1 and the image-side surfaces L2A2, L3A2, L4A2, L5A2, and positive or negative configuration of the refracting power of each lens element other than the third lens element L3 and the fourth lens element L4 may be similar to those in the first embodiment. Specifically, the third lens element L3 has positive refracting power, the fourth lens element L4 has negative refracting power, a periphery region L1A2P of the image-side surface L1A2 of the first lens element L1 is convex, an optical axis region L3A1C of the object-side surface L3A1 of the third lens element L3 is convex, and a periphery region L3A1P of the object-side surface L3A1 of the third lens element L3 is convex.

Here and in the embodiments hereinafter, for clearly showing the drawings of the present embodiment, only the surface shapes which are different from that in the first embodiment may be labeled. Please refer to FIG. 32 for the optical characteristics of each lens elements in the optical imaging lens 7 of the present embodiment.

As the longitudinal spherical aberration of three different wavelengths (470 nm, 555 nm, 650 nm) as shown in FIG. 31(a), the offset of the off-axis light relative to the image point may be within ±0.03 mm. As the field curvature aberration in the sagittal direction shown in FIG. 31(b), the focus variation with regard to the three wavelengths in the whole field may fall within ±30 μm. As the field curvature aberration in the tangential direction shown in FIG. 31(c), the focus variation with regard to the three wavelengths in the whole field may fall within ±30 μm. As shown in FIG. 31(d), the variation of the distortion aberration may be within ±4.5%.

As shown in FIGS. 31(a)-31(d) and 32, compared with the first embodiment, the longitudinal spherical aberration, the field curvature aberration in both the sagittal and tangential directions, distortion aberration and f-number of the present embodiment are smaller.

Please refer to FIG. 43B for the values of EFL/(ImgH*Fno), V3, V4, V5, HFOV/AAG, HFOV*Fno/EFL, TL/(G23+G34), HFOV/D11t22, (ALT+BFL+ImgH)/(G23+G34), HFOV*Fno/TTL, HFOV*Fno/TL, HFOV/(G45+T5), EFL/ImgH, (D31t52+BFL)/D11t22, D31t52/(T2+T3), (ALT+BFL)*Fno/D22t41, (T1+T4+T5)/T3, (T1+G12+T4+T5)/(T2+T3) of the present embodiment.

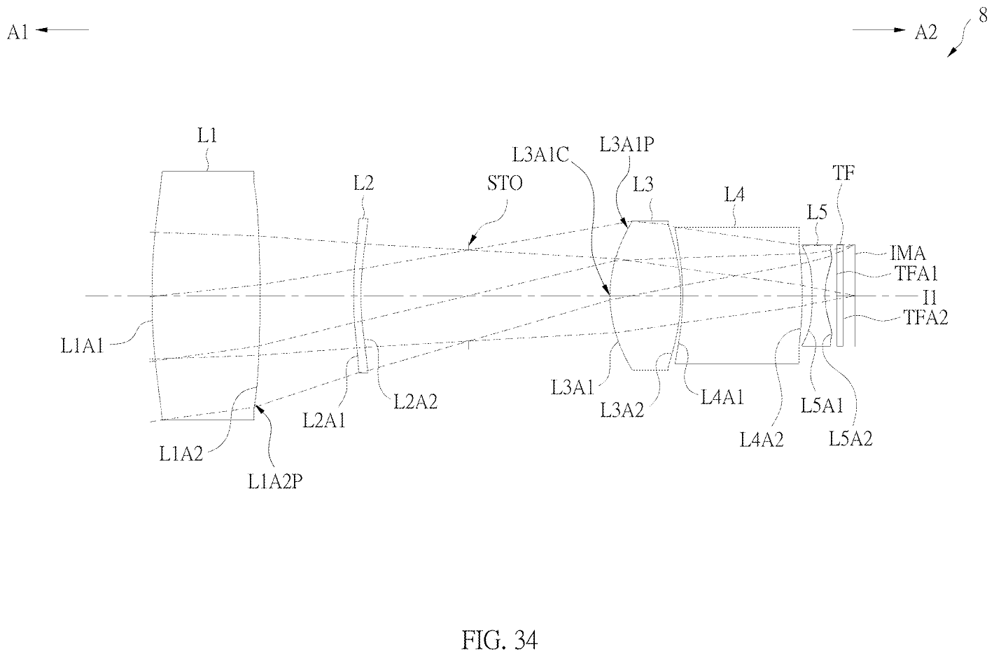

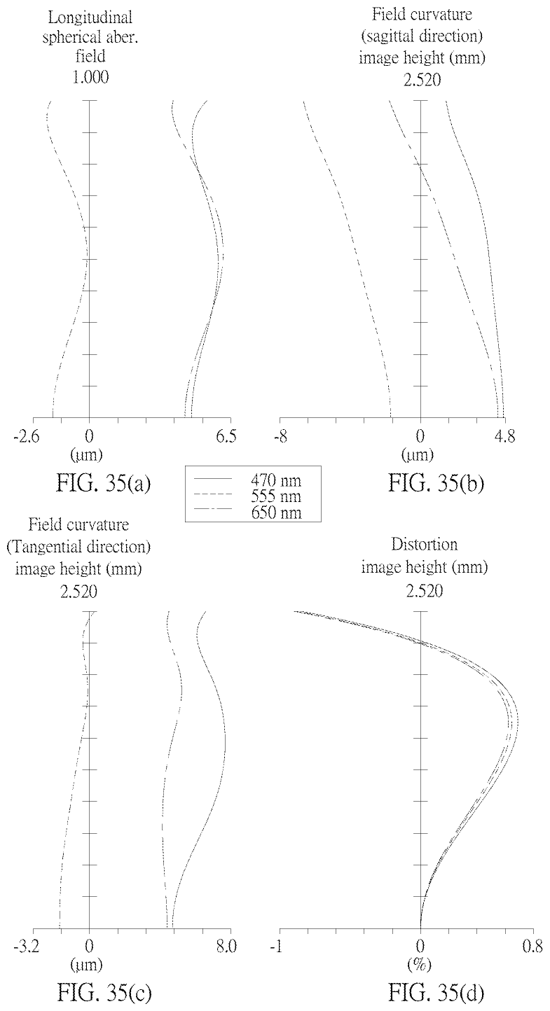

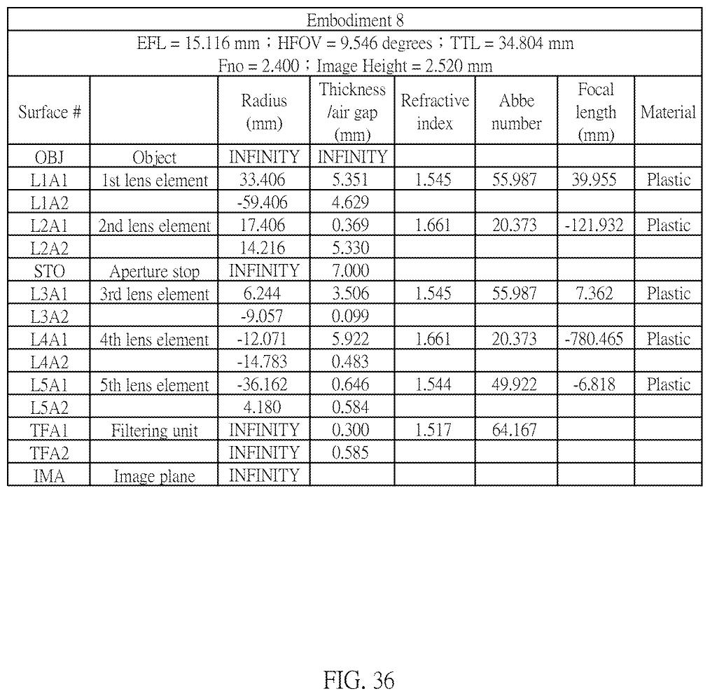

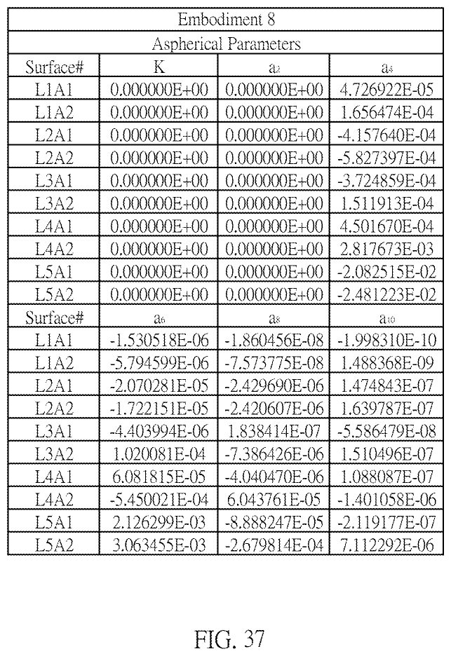

Reference is now made to FIGS. 34-37. FIG. 34 illustrates an example cross-sectional view of an optical imaging lens 8 having five lens elements of the optical imaging lens according to an eighth example embodiment. FIGS. 35(a)-35(d) show example charts of a longitudinal spherical aberration and other kinds of optical aberrations of the optical imaging lens 8 according to the eighth example embodiment. FIG. 36 shows an example table of optical data of each lens element of the optical imaging lens 8 according to the eighth example embodiment. FIG. 37 shows an example table of aspherical data of the optical imaging lens 8 according to the eighth example embodiment.

As shown in FIG. 34, the optical imaging lens 8 of the present embodiment, in an order from an object side A1 to an image side A2 along an optical axis, may comprise a first lens element L1, a second lens element L2, an aperture stop STO, a third lens element L3, a fourth lens element L4 and a fifth lens element L5.

The differences between the eighth embodiment and the first embodiment may include the radius of curvature, thickness of each lens element, aspherical data, related optical parameters, such as effective focal length, and the configuration of the concave/convex shape of the object-side surface L3A1 and the image-side surface L1A2; but the configuration of the concave/convex shape of surfaces, comprising the object-side surfaces L1A1, L2A1, L4A1, L5A1 and the image-side surfaces L2A2, L3A2, L4A2, L5A2, and positive or negative configuration of the refracting power of each lens element other than the third lens element L3 and the fourth lens element L4 may be similar to those in the first embodiment. Specifically, the third lens element L3 has positive refracting power, the fourth lens element L4 has negative refracting power, a periphery region L1A2P of the image-side surface L1A2 of the first lens element L1 is convex, an optical axis region L3A1C of the object-side surface L3A1 of the third lens element L3 is convex, and a periphery region L3A1P of the object-side surface L3A1 of the third lens element L3 is convex.

Here and in the embodiments hereinafter, for clearly showing the drawings of the present embodiment, only the surface shapes which are different from that in the first embodiment may be labeled. Please refer to FIG. 36 for the optical characteristics of each lens elements in the optical imaging lens 8 of the present embodiment.

As the longitudinal spherical aberration of three different wavelengths (470 nm, 555 nm, 650 nm) as shown in FIG. 35(a), the offset of the off-axis light relative to the image point may be within ±6.5 μm. As the field curvature aberration in the sagittal direction shown in FIG. 35(b), the focus variation with regard to the three wavelengths in the whole field may fall within ±8 μm. As the field curvature aberration in the tangential direction shown in FIG. 35(c), the focus variation with regard to the three wavelengths in the whole field may fall within ±8 μm. As shown in FIG. 35(d), the variation of the distortion aberration may be within ±1%.

As shown in FIGS. 35(a)-35(d) and 36, compared with the first embodiment, the longitudinal spherical aberration, the field curvature aberration in both the sagittal and tangential directions, distortion aberration and f-number of the present embodiment are smaller.

Please refer to FIG. 43B for the values of EFL/(ImgH*Fno), V3, V4, V5, HFOV/AAG, HFOV*Fno/EFL, TL/(G23+G34), HFOV/D11t22, (ALT+BFL+ImgH)/(G23+G34), HFOV*Fno/TTL, HFOV*Fno/TL, HFOV/(G45+T5), EFL/ImgH, (D31t52+BFL)/D11t22, D31t52/(T2+T3), (ALT+BFL)*Fno/D22t41, (T1+T4+T5)/T3, (T1+G12+T4+T5)/(T2+T3) of the present embodiment.

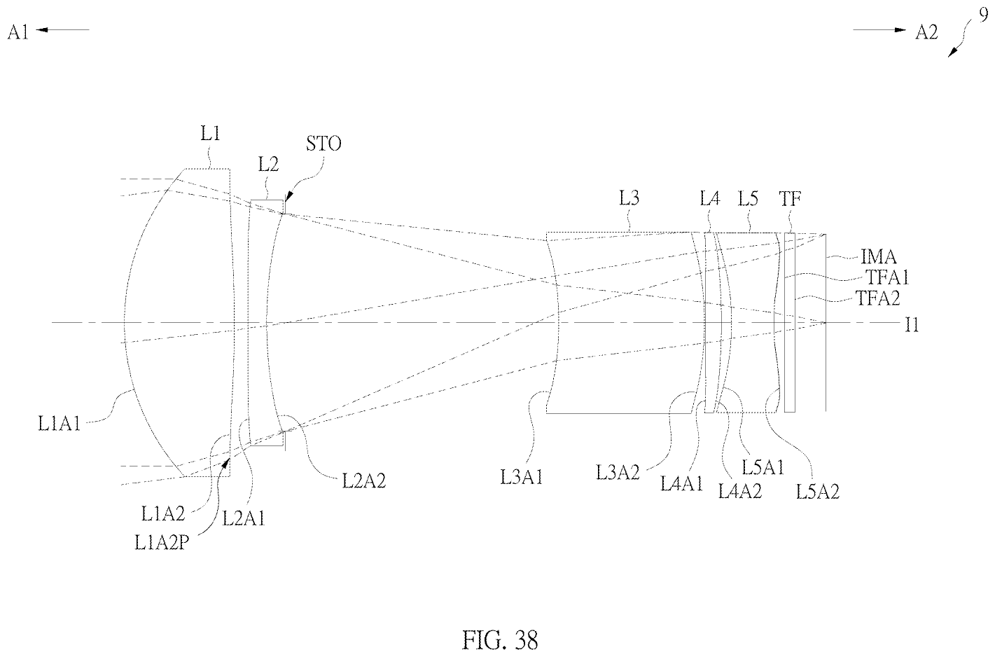

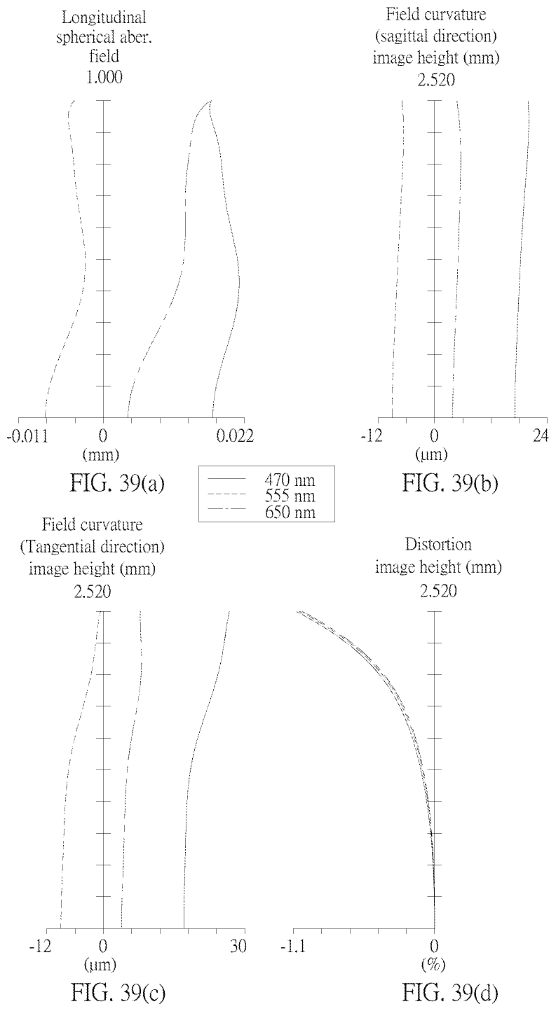

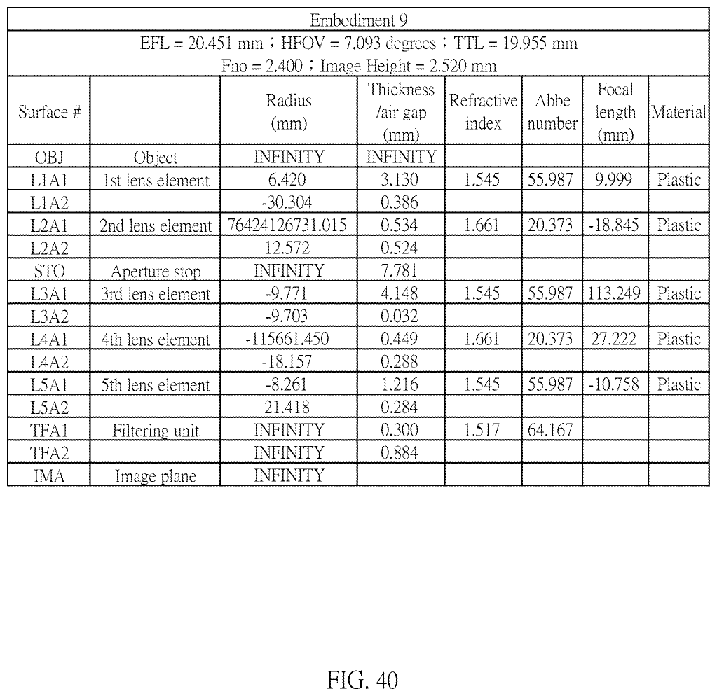

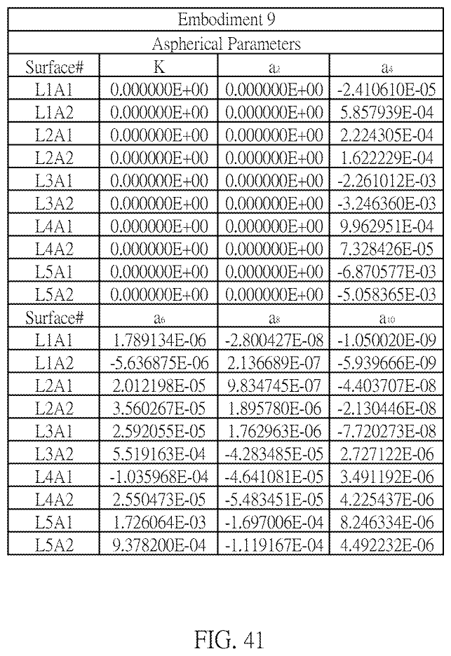

Reference is now made to FIGS. 38-41. FIG. 38 illustrates an example cross-sectional view of an optical imaging lens 9 having five lens elements of the optical imaging lens according to a ninth example embodiment. FIGS. 39(a)-39(d) show example charts of a longitudinal spherical aberration and other kinds of optical aberrations of the optical imaging lens 9 according to the ninth example embodiment. FIG. 40 shows an example table of optical data of each lens element of the optical imaging lens 9 according to the ninth example embodiment. FIG. 41 shows an example table of aspherical data of the optical imaging lens 9 according to the ninth example embodiment.

As shown in FIG. 38, the optical imaging lens 9 of the present embodiment, in an order from an object side A1 to an image side A2 along an optical axis, may comprise a first lens element L1, a second lens element L2, an aperture stop STO, a third lens element L3, a fourth lens element L4 and a fifth lens element L5.

The differences between the ninth embodiment and the first embodiment may include the radius of curvature, thickness of each lens element, aspherical data, related optical parameters, such as effective focal length, and the configuration of the concave/convex shape of the image-side surface L1A2; but the configuration of the concave/convex shape of surfaces, comprising the object-side surfaces L1A1, L2A1, L3A1, L4A1, L5A1 and the image-side surfaces L2A2, L3A2, L4A2, L5A2, and positive or negative configuration of the refracting power of each lens element other than the third lens element L3 may be similar to those in the first embodiment. Specifically, the third lens element L3 has positive refracting power, a periphery region L1A2P of the image-side surface L1A2 of the first lens element L1 is convex.

Here and in the embodiments hereinafter, for clearly showing the drawings of the present embodiment, only the surface shapes which are different from that in the first embodiment may be labeled. Please refer to FIG. 40 for the optical characteristics of each lens elements in the optical imaging lens 9 of the present embodiment.

As the longitudinal spherical aberration of three different wavelengths (470 nm, 555 nm, 650 nm) as shown in FIG. 39(a), the offset of the off-axis light relative to the image point may be within ±0.022 mm. As the field curvature aberration in the sagittal direction shown in FIG. 39(b), the focus variation with regard to the three wavelengths in the whole field may fall within ±24 μm. As the field curvature aberration in the tangential direction shown in FIG. 39(c), the focus variation with regard to the three wavelengths in the whole field may fall within ±30 μm. As shown in FIG. 39(d), the variation of the distortion aberration may be within ±1.1%.

As shown in FIGS. 39(a)-39(d) and 40, compared with the first embodiment, the longitudinal spherical aberration, the field curvature aberration in both the sagittal and tangential directions, distortion aberration and f-number of the present embodiment are smaller, and the effective focal length of the present embodiment is greater.

Please refer to FIG. 43B for the values of EFL/(ImgH*Fno), V3, V4, V5, HFOV/AAG, HFOV*Fno/EFL, TL/(G23+G34), HFOV/D11t22, (ALT+BFL+ImgH)/(G23+G34), HFOV*Fno/TTL, HFOV*Fno/TL, HFOV/(G45+T5), EFL/ImgH, (D31t52+BFL)/D11t22, D31t52/(T2+T3), (ALT+BFL)*Fno/D22t41, (T1+T4+T5)/T3, (T1+G12+T4+T5)/(T2+T3) of the present embodiment.

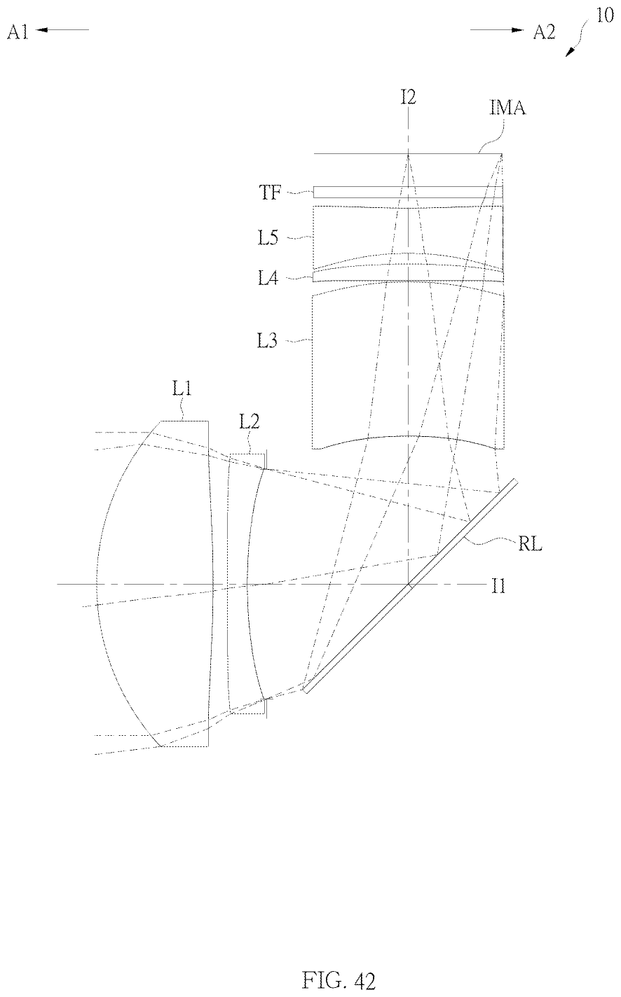

Reference is now made to FIG. 42 which illustrates an example cross-sectional view of an optical imaging lens 10 having five lens elements of the optical imaging lens according to a tenth example embodiment.

As shown in FIG. 42, the optical imaging lens 10 of the present embodiment, in an order from an object side A1 to an image side A2 along an optical axis, may comprise a first lens element L1, a second lens element L2, an aperture stop STO, a third lens element L3, a fourth lens element L4 and a fifth lens element L5. The differences between the tenth embodiment and the first embodiment may include the first and second lens elements L1, L2 and aperture stop STO are positioned along with an optical axis I1, and the third, fourth and fifth lens elements L3, L4, L5 are positioned along with a second optical axis I2. The optical axis I1 is different from the second optical axis I2, and the optical axis I1 intersects with the second optical axis I2. Further, the optical imaging lens 10 further comprise a reflective device RL positioned between the second and third lens elements L2, L3 and at the intersection point of the optical axis I1 and the second optical axis I2 to reflect imaging rays passing through the image-side surface L2A2 of the second lens element L2 to the object-side surface L3A1 of the third lens element L3. The reflective device RL may be a flat mirror.

The configuration of the concave/convex shape of surfaces, comprising the object-side surfaces L1A1, L2A1, L3A1, L4A1, L5A1 and the image-side surfaces L1A2, L2A2, L3A2, L4A2, L5A2, and positive or negative configuration of the refracting power of each lens element may be the same as those in the first embodiment. Further, the radius of curvature, thickness of each lens element, aspherical data, related optical parameters, such as effective focal length may be the same as those in the first embodiment. Therefore, FIGS. 39(a)-39(d) may be referred for the longitudinal spherical aberration and other kinds of optical aberrations of the optical imaging lens 10 of the present embodiment, FIG. 40 may be referred for the table of optical data of each lens element of the optical imaging lens 10 of the present embodiment, FIG. 41 may be referred for the table of aspherical data of the optical imaging lens 10 of the present embodiment.

It should be understood that compared with the first embodiment, the longitudinal spherical aberration, the field curvature aberration in both the sagittal and tangential directions, distortion aberration and f-number of the present embodiment are smaller, and the effective focal length of the present embodiment is greater.

Please refer to FIG. 43B for the values of EFL/(ImgH*Fno), V3, V4, V5, HFOV/AAG, HFOV*Fno/EFL, TL/(G23+G34), HFOV/D11t22, (ALT+BFL+ImgH)/(G23+G34), HFOV*Fno/TTL, HFOV*Fno/TL, HFOV/(G45+T5), EFL/ImgH, (D31t52+BFL)/D11t22, D31t52/(T2+T3), (ALT+BFL)*Fno/D22t41, (T1+T4+T5)/T3, (T1+G12+T4+T5)/(T2+T3) of the present embodiment.

Example embodiments of the present inventions may provide optical imaging lenses with small f-number, long effective focal length and good imaging quality through controlling refracting power and concave/convex configuration of lens elements. For example, the three combinations listed below may facilitate adjustment of longitudinal spherical aberration, aberration and distortion aberration: the second lens element may have negative refracting power, a periphery region of the object-side surface of the second lens element is convex, an optical axis region of the image-side surface of the third lens element is convex, a periphery region of the image-side surface of the fourth lens element is convex, and a periphery region of the image-side surface of the fifth lens element is convex; a periphery region of the object-side surface of the second lens element is convex, a periphery region of the image-side surface of the third lens element is convex, a periphery region of the image-side surface of the fourth lens element is convex, an optical axis region of the image-side surface of the fifth lens element is concave, and a periphery region of the image-side surface of the fifth lens element is convex; and an optical axis region of the image-side surface of the first lens element is convex, an optical axis region of the object-side surface of the second lens element is convex, a periphery region of the object-side surface of the fourth lens element is concave, a periphery region of the image-side surface of the fourth lens element is convex, an optical axis region of the image-side surface of the fifth lens element is concave, and a periphery region of the image-side surface of the fifth lens element is convex.

All of the numerical ranges including the maximum and minimum values and the values therebetween which are obtained from the combining proportion relation of the optical parameters disclosed in each embodiment of the present disclosure are implementable.

According to above illustration, the longitudinal spherical aberration, field curvature aberration in both the sagittal direction and tangential direction and distortion aberration in all embodiments may meet the user requirement of a related product in the market. The off-axis light with regard to three different wavelengths may be focused around an image point and the offset of the off-axis light relative to the image point may be well controlled with suppression for the longitudinal spherical aberration, field curvature aberration both in the sagittal direction and tangential direction and distortion aberration. The curves of different wavelengths may be close to each other, and this represents that the focusing for light having different wavelengths may be good to suppress chromatic dispersion. In summary, lens elements are designed and matched for achieving good imaging quality.

In light of the unpredictability in an optical system, satisfying these inequalities listed above may result in shortening the system length of the optical imaging lens, decreasing longitudinal spherical aberration, field curvature aberration in both the sagittal direction and tangential direction and distortion aberration, promoting the imaging quality, and/or increasing the yield in the assembly process in the present disclosure.

While various embodiments in accordance with the disclosed principles are described above, it should be understood that they are presented by way of example only, and are not limiting. Thus, the breadth and scope of example embodiment(s) should not be limited by any of the above-described embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically, a description of a technology in the “Background” is not to be construed as an admission that technology is prior art to any invention(s) in this disclosure. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings herein.

What is claimed is:

1. An optical imaging lens, comprising a first lens element, a second lens element, a third lens element, a fourth lens element and a fifth lens element sequentially from an object side to an image side along an optical axis, each of the first, second, third, fourth and fifth lens element having an object-side surface facing toward the object side and allowing imaging rays to pass through and an image-side surface facing toward the image side and allowing the imaging rays to pass through, wherein:
the second lens element has negative refracting power;
a periphery region of the object-side surface of the second lens element is convex;
an optical axis region of the image-side surface of the third lens element is convex;
a periphery region of the image-side surface of the fourth lens element is convex;
a periphery region of the image-side surface of the fifth lens element is convex;
lens elements included by the optical imaging lens are only the five lens elements described above; and
an effective focal length of the optical imaging lens is represented by EFL, an image height of the optical imaging lens is represented by ImgH, a f-number of the optical imaging lens is represented by Fno, and the optical imaging lens satisfies the inequality:
EFL/(ImgH*Fno)≥1.800.

2. The optical imaging lens according to claim 1, wherein an abbe number of the third lens element is represented by V3, and V3 satisfies the inequality:
V3≥49.000.

3. The optical imaging lens according to claim 1, wherein a half field of view of the optical imaging lens is represented by HFOV, a sum of four air gaps from the first lens element to the fifth lens element along the optical axis is represented by AAG, and HFOV and AAG satisfy the inequality:
HFOV/AAG≤4.500 degree/mm.

4. The optical imaging lens according to claim 1, wherein a half field of view of the optical imaging lens is represented by HFOV, and HFOV, Fno and EFL satisfy the inequality:
HFOV*Fno/EFL≤2.200 degree/mm.

5. The optical imaging lens according to claim 1, wherein a distance from the object-side surface of the first lens element to the image-side surface of the fifth lens element along the optical axis is represented by TL, a distance from the image-side surface of the second lens element to the object-side surface of the third lens element along the optical axis is represented by G23, a distance from the image-side surface of the third lens element to the object-side surface of the fourth lens element along the optical axis is represented by G34, TL, G23 and G34 satisfy the inequality:
TL/(G23+G34)≤3.600.

6. The optical imaging lens according to claim 1, wherein a half field of view of the optical imaging lens is represented by HFOV, a distance from the object-side surface of the first lens element to the image-side surface of the second lens element along the optical axis is represented by D11t22, and HFOV and D11t22 satisfy the inequality:
HFOV/D11t22≤5.000 degree/mm.

7. The optical imaging lens according to claim 1, wherein a sum of the thicknesses of all five lens elements along the optical axis is represented by ALT, a distance from the image-side surface of the fifth lens element to an image plane along the optical axis is represented by BFL, a distance from the image-side surface of the second lens element to the object-side surface of the third lens element along the optical axis is represented by G23, a distance from the image-side surface of the third lens element to the object-side surface of the fourth lens element along the optical axis is represented by G34, and ALT, BFL, ImgH, G23 and G34 satisfy the inequality:
(ALT+BFL+ImgH)/(G23+G34)≤4.900.

8. An optical imaging lens, comprising a first lens element, a second lens element, a third lens element, a fourth lens element and a fifth lens element sequentially from an object side to an image side along an optical axis, each of the first, second, third, fourth and fifth lens element having an object-side surface facing toward the object side and allowing imaging rays to pass through and an image-side surface facing toward the image side and allowing the imaging rays to pass through, wherein:
a periphery region of the object-side surface of the second lens element is convex;
a periphery region of the image-side surface of the third lens element is convex;
a periphery region of the image-side surface of the fourth lens element is convex;
an optical axis region of the image-side surface of the fifth lens element is concave;
a periphery region of the image-side surface of the fifth lens element is convex;
lens elements included by the optical imaging lens are only the five lens elements described above; and
an effective focal length of the optical imaging lens is represented by EFL, an image height of the optical imaging lens is represented by ImgH, a f-number of the optical imaging lens is represented by Fno, and the optical imaging lens satisfies the inequality:
EFL/(ImgH*Fno)≥1.800.

9. The optical imaging lens according to claim 8, wherein an abbe number of the fourth lens element is represented by V4, and V4 satisfies the inequality:
V4≤40.000.

10. The optical imaging lens according to claim 8, wherein a half field of view of the optical imaging lens is represented by HFOV, a distance from the object-side surface of the first lens element to an image plane along the optical axis is represented by TTL, and HFOV, Fno and TTL satisfy the inequality:
HFOV*Fno/TTL≤2.400 degree/mm.

11. The optical imaging lens according to claim 8, wherein a half field of view of the optical imaging lens is represented by HFOV, a distance from the object-side surface of the first lens element to the image-side surface of the fifth lens element along the optical axis is represented by TL, and HFOV, Fno and TL satisfy the inequality:
HFOV*Fno/TL≤4.200 degree/mm.

12. The optical imaging lens according to claim 8, wherein a half field of view of the optical imaging lens is represented by HFOV, a distance from the image-side surface of the fourth lens element to the object-side surface of the fifth lens element along the optical axis is represented by G45, a thickness of the fifth lens element along the optical axis is represented by T5, and HFOV, G45 and T5 satisfy the inequality:
HFOV/(G45+T5)≤11.700 degree/mm.

13. The optical imaging lens according to claim 8, wherein EFL and ImgH satisfy the inequality:
EFL/ImgH≥5.900.

14. The optical imaging lens according to claim 8, wherein a distance from the object-side surface of the third lens element to the image-side surface of the fifth lens element along the optical axis is represented by D31t52, a distance from the image-side surface of the fifth lens element to an image plane along the optical axis is represented by BFL, a distance from the object-side surface of the first lens element to the image-side surface of the second lens element along the optical axis is represented by D11t22, and D31t52, BFL and D11t22 satisfy the inequality:
(D31t52+BFL)/D11t22≤2.600.

15. An optical imaging lens, comprising a first lens element, a second lens element, a third lens element, a fourth lens element and a fifth lens element sequentially from an object side to an image side along an optical axis, each of the first, second, third, fourth and fifth lens element having an object-side surface facing toward the object side and allowing imaging rays to pass through and an image-side surface facing toward the image side and allowing the imaging rays to pass through, wherein:
an optical axis region of the image-side surface of the first lens element is convex;
an optical axis region of the object-side surface of the second lens element is convex;
a periphery region of the object-side surface of the fourth lens element is concave;
a periphery region of the image-side surface of the fourth lens element is convex;
an optical axis region of the image-side surface of the fifth lens element is concave;
a periphery region of the image-side surface of the fifth lens element is convex;
lens elements included by the optical imaging lens are only the five lens elements described above; and
an effective focal length of the optical imaging lens is represented by EFL, an image height of the optical imaging lens is represented by ImgH, a f-number of the optical imaging lens is represented by Fno, and the optical imaging lens satisfies the inequality:
EFL/(ImgH*Fno)≥1.800.

16. The optical imaging lens according to claim 15, wherein an abbe number of the fifth lens element is represented by V5, and V5 satisfies the inequality:
V5≥49.000.

17. The optical imaging lens according to claim 15, wherein a distance from the object-side surface of the third lens element to the image-side surface of the fifth lens element along the optical axis is represented by D31t52, a thickness of the second lens element along the optical axis is represented by T2, a thickness of the third lens element along the optical axis is represented by T3, and D31t52, T2 and T3 satisfy the inequality:
D31t52/(T2+T3)≤4.500.

18. The optical imaging lens according to claim 15, wherein a sum of the thicknesses of all five lens elements from the first lens element to the fifth lens element along the optical axis is represented by ALT, a distance from the image-side surface of the seventh lens element to an image plane along the optical axis is represented by BFL, a distance from the image-side surface of the second lens element to the object-side surface of the fourth lens element along the optical axis is represented by D22t41, and ALT, BFL, Fno and D22t41 satisfy the inequality:
(ALT+BFL)*Fno/D22t41≤2.750.

19. The optical imaging lens according to claim 15, wherein a thickness of the first lens element along the optical axis is represented by T1, a thickness of the fourth lens element along the optical axis is represented by T4, a thickness of the fifth lens element along the optical axis is represented by T5, a thickness of the third lens element along the optical axis is represented by T3, and T1, T4, T5 and T3 satisfy the inequality:
(T1+T4+T5)/T3≤5.600.

20. The optical imaging lens according to claim 15, wherein a thickness of the first lens element along the optical axis is represented by T1, a distance from the image-side surface of the first lens element to the object-side surface of the second lens element along the optical axis is represented by G12, a thickness of the fourth lens element along the optical axis is represented by T4, a thickness of the fifth lens element along the optical axis is represented by T5, a thickness of the second lens element along the optical axis is represented by T2, a thickness of the third lens element along the optical axis is represented by T3, and T1, G12, T4, T5, T2 and T3 satisfy the inequality:
(T1+G12+T4+T5)/(T2+T3)≤5.200.
